(19) United States
(12) Patent Application Publication
(10) Pub. No.: US 2022/0158227 A1
(43) Pub. Date: May 19, 2022

(54) PRECURSOR COMPOSITION FOR SOLID ELECTROLYTE, AND METHOD FOR PRODUCING SECONDARY BATTERY

(71) Applicant: Seiko Epson Corporation, Tokyo (JP)

(72) Inventors: Tomofumi YOKOYAMA, Matsumoto (JP); Hitoshi YAMAMOTO, Chino (JP); Masahiro FURUSAWA, Chino (JP); Tsutomu TERAOKA, Matsumoto (JP)

(21) Appl. No.: 17/433,105

(22) PCT Filed: Nov. 21, 2019
(86) PCT No.: PCT/JP2019/045708

§ 371 Date: Aug. 23, 2021

(30) Foreign Application Priority Data
Feb. 26, 2019 (JP) 2019-032429

(51) Int. Cl. H01M 10/0562; H01M 10/0525; H01M 4/04

(52) U.S. Cl. CPC H01M 10/0562; H01M 2004/027; H01M 4/0407; H01M 10/0525

(57) ABSTRACT

A precursor composition for a solid electrolyte is provided that is capable of achieving a high lithium ion conductivity even if the precursor composition is sintered at a temperature of 1000° C. or lower. The precursor composition for the solid electrolyte is a precursor composition for a garnet-type or garnet-like solid electrolyte containing Li, La, Zr, and M, wherein the M is one or more types of elements selected from Nb, Ta, and Sb, the compositional ratio of Li:La:Zr:M in the solid electrolyte is 7-x:3:2-x:x, a relationship of 0<x<2.0 is satisfied, and the precursor composition exhibits X-ray diffraction intensity peaks at diffraction angles 2θ of 28.4°, 32.88°, 47.2°, 56.01°, and 58.73° in an X-ray diffraction pattern.

### CROSS REFERENCE TO RELATED APPLICATIONS

This application is a U.S. National Phase Application under 35 U.S.C. 371 of International Application No. PCT/JP2019/045708, filed on Nov. 21, 2019, which claims priority to Japanese Patent Application No. 2019-032429, filed on Feb. 26, 2019. The entire disclosures of the above applications are expressly incorporated by reference herein.

### BACKGROUND

### Technical Field

The present invention relates to a precursor composition for a solid electrolyte to be used for a secondary battery, and a method for producing a secondary battery.

### Background Art

As a secondary battery using a solid electrolyte, for example, PTL 1 discloses an all-solid-state lithium secondary battery including a positive electrode, a negative electrode, and a solid electrolyte containing a ceramic having a garnet-type or garnet-like crystal structure composed of lithium (Li), lanthanum (La), zirconium (Zr), and oxygen (O).

Further, the above-mentioned PTL 1 discloses a method for producing a solid electrolyte material including a step of preparing a raw material containing a Li component, a La component, and a Zr component, and a step of obtaining a ceramic having a garnet-type or garnet-like crystal structure composed of Li, La, Zr, and O by subjecting the raw material to a heat treatment at a temperature higher than 1125° C. and lower than 1230° C. In addition, an example in which Li₂CO₃ is used as the Li component, La(OH)₃ or La₂O₃ is used as the La component, and ZrO₂ is used as the Zr component is mentioned. In the chemical formulation of a solid electrolyte obtained using the method for producing a solid electrolyte material, Li is stoichiometrically equivalent to or less than that of Li₇La₃Zr₂O₁₂ that is a garnet-type ceramic, and therefore, the chemical formulation is said to be given by Li₇₋ₓLa₃Zr₂O₁₂ (0≤x≤1.0).

### CITATION LIST

### Patent Literature

PTL 1: JP-A-2010-45019

### Technical Problem

In the method for producing a solid electrolyte material disclosed in the above-mentioned PTL 1, it is said to be preferred that a mixture obtained by compounding and mixing the Li component, the La component, and the Zr component, each of which is a powder, based on the compositional ratio of the solid electrolyte is subjected to a heat treatment at a temperature higher than 1125° C. and lower than 1230° C. for 30 hours or more and 50 hours or less. However, the temperature of the heat treatment is higher than 1000° C. and the heat treatment time is long, and therefore, it had a problem that Li is likely to volatilize, and it is difficult to achieve a desired lithium ion conductivity in the solid electrolyte to be obtained.

### SUMMARY

A precursor composition for a solid electrolyte of this application is a precursor composition for a garnet-type or garnet-like solid electrolyte containing Li, La, Zr, and M, and is characterized in that the M is one or more types of elements selected from Nb, Ta, and Sb, the compositional ratio of Li:La:Zr:M in the solid electrolyte is 7-x:3:2-x:x, a relationship of 0<x<2.0 is satisfied, and the precursor composition exhibits X-ray diffraction intensity peaks at diffraction angles 2θ of 28.4°, 32.88°, 47.2°, 56.01°, and 58.73° in an X-ray diffraction pattern.

It is preferred that the precursor composition for a solid electrolyte described above contains nitrate ions.

It is preferred that in the precursor composition for a solid electrolyte described above, the M is two or more types of elements selected from Nb, Ta, and Sb.

A method for producing a secondary battery of this application is characterized by including a step of forming a solid electrolyte layer by forming a molded material using the precursor composition for a solid electrolyte described above, and sintering the molded material, a step of forming a positive electrode at one face of the solid electrolyte layer, a step of forming a negative electrode at the other face of the solid electrolyte layer, and a step of forming a current collector in contact with at least one of the positive electrode and the negative electrode.

Further, another method for producing a secondary battery of this application is characterized by including a step of forming a positive electrode composite material by forming a molded material including the precursor composition for a solid electrolyte described above and a positive electrode active material, and sintering the molded material, a step of forming a negative electrode at one face of the positive electrode composite material, and a step of forming a current collector at the other face of the positive electrode composite material.

Further, another method for producing a secondary battery of this application is characterized by including a step of forming a negative electrode composite material by forming a molded material including the precursor composition for a solid electrolyte described above and a negative electrode active material, and sintering the molded material, a step of forming a positive electrode at one face of the negative electrode composite material, and a step of forming a current collector at the other face of the negative electrode composite material.

Another method for producing a secondary battery of this application is characterized by including a step of forming a sheet of a positive electrode composite material mixture including the precursor composition for a solid electrolyte described above and a positive electrode active material, a step of forming a sheet of a negative electrode composite material mixture including the precursor composition for a solid electrolyte described above and a negative electrode active material, a step of forming a sheet of an electrolyte mixture including a solid electrolyte, a step of forming a stacked body by stacking the sheet of the positive electrode composite material mixture, the sheet of the electrolyte mixture, and the sheet of the negative electrode composite material mixture in this order, a step of forming a molded material by molding the stacked body, a step of firing the molded material, and a step of forming a current collector at at least one face of the fired molded material.

It is preferred that in the another method for producing a secondary battery described above, the solid electrolyte is formed using the precursor composition for a solid electrolyte described above.

### BRIEF DESCRIPTION OF THE DRAWINGS

FIG. 1 is a schematic perspective view showing a configuration of a lithium-ion battery as a secondary battery of a first embodiment.

FIG. 2 is a flowchart showing a method for producing the lithium-ion battery as the secondary battery of the first embodiment.

FIG. 3 is a schematic view showing the method for producing the lithium-ion battery as the secondary battery of the first embodiment.

FIG. 4 is a schematic view showing the method for producing the lithium-ion battery as the secondary battery of the first embodiment.

FIG. 5 is a schematic cross-sectional view showing another method for forming a solid electrolyte layer.

FIG. 6 is a schematic perspective view showing a configuration of a lithium-ion battery as a secondary battery of a second embodiment.

FIG. 7 is a schematic cross-sectional view showing a structure of the lithium-ion battery as the secondary battery of the second embodiment.

FIG. 8 is a flowchart showing a method for producing the lithium-ion battery as the secondary battery of the second embodiment.

FIG. 9 is a schematic view showing the method for producing the lithium-ion battery as the secondary battery of the second embodiment.

FIG. 10 is a schematic view showing the method for producing the lithium-ion battery as the secondary battery of the second embodiment.

FIG. 11 is a schematic perspective view showing a configuration of a lithium-ion battery as a secondary battery of a third embodiment.

FIG. 12 is a schematic cross-sectional view showing a structure of the lithium-ion battery as the secondary battery of the third embodiment.

FIG. 13 is a flowchart showing a method for producing the lithium-ion battery as the secondary battery of the third embodiment.

FIG. 14 is a schematic view showing the method for producing the lithium-ion battery as the secondary battery of the third embodiment.

FIG. 15 is a schematic view showing the method for producing the lithium-ion battery as the secondary battery of the third embodiment.

FIG. 16 is a schematic perspective view showing a configuration of a lithium-ion battery as a secondary battery of a fourth embodiment.

FIG. 17 is a schematic cross-sectional view showing a structure of the lithium-ion battery as the secondary battery of the fourth embodiment.

FIG. 18 is a flowchart showing a method for producing the lithium-ion battery as the secondary battery of the fourth embodiment.

FIG. 19 is a schematic view showing the method for producing the lithium-ion battery as the secondary battery of the fourth embodiment.

FIG. 20 is a schematic view showing the method for producing the lithium-ion battery as the secondary battery of the fourth embodiment.

FIG. 21 is a schematic view showing the method for producing the lithium-ion battery as the secondary battery of the fourth embodiment.

FIG. 22 is a schematic view showing the method for producing the lithium-ion battery as the secondary battery of the fourth embodiment.

FIG. 23 is a graph showing X-ray diffraction patterns of precursor compositions for solid electrolytes of Examples 1 to 5.

FIG. 24 is a graph showing X-ray diffraction patterns of precursor compositions for solid electrolytes of Examples 6 and 7, a thermal decomposition product of Comparative Example 1, and a mixture of Comparative Example 2.

FIG. 25 is a graph showing X-ray diffraction patterns of solid electrolytes of Examples 1 to 5.

FIG. 26 is a graph showing X-ray diffraction patterns of solid electrolytes of Examples 6 and 7 and Comparative Examples 1 to 2.

FIG. 27 is a graph showing X-ray diffraction patterns of solid electrolytes of Examples 8 and 9.

### DETAILED DESCRIPTION

Hereinafter, embodiments of the invention will be described with reference to the drawings as needed. Note that in the respective drawings below, portions to be described are shown by being appropriately enlarged or reduced in size so as to have a recognizable size.

### 1. FIRST EMBODIMENT

### 1-1. Precursor Composition for Solid Electrolyte

A precursor composition for a solid electrolyte of this embodiment contains lithium (Li), lanthanum (La), zirconium (Zr), and M, wherein the M is one or more types of elements selected from Nb, Ta, and Sb, the compositional ratio of Li:La:Zr:M in the solid electrolyte is 7-x:3:2-x:x, and a relationship of 0<x<2.0 is satisfied. Further, an X-ray diffraction pattern of the precursor composition by X-ray diffractometry (XRD) exhibits X-ray diffraction intensity peaks at diffraction angles 2θ of 28.4°, 32.88°, 47.2°, 56.01°, and 58.73°.

By using the precursor composition for a solid electrolyte of this embodiment and sintering the composition through a heat treatment at a high temperature, a solid electrolyte that is a garnet-type or garnet-like lithium composite metal oxide represented by the following compositional formula (1) can be obtained.

Li₇₋ₓLa₃(Zr₂₋ₓ,Mₓ)O₁₂ (1)

In the above compositional formula (1), as the element M, one or more types are selected from Nb, Ta, and Sb, and x satisfies 0<x<2.0.

A method for producing such a precursor composition for a solid electrolyte will be described. First, a mixed solution in which raw material solutions prepared by dissolving each of a lithium compound, a lanthanum compound, a zirconium compound, and a compound containing the element M, each of which is soluble in a solvent, in the solvent are compounded based on the stoichiometric formulation represented by the above compositional formula (1) is prepared. Then, a first heating treatment for removing a solvent component from the mixed solution is performed thereby obtaining a mixture. The conditions of the first heating treatment depend on the boiling point and vapor pressure of the solvent, but for example, the heating temperature is 50° C. or higher and 250° C. or lower, and the heating time is from 30 minutes to 1 hour. Subsequently, the mixture is subjected to a second heating treatment in an oxidative atmosphere thereby obtaining a precursor composition for a solid electrolyte. The conditions of the second heating treatment are, for example, such that the heating temperature is 450° C. or higher and 550° C. or lower, and the heating time is from 1 hour to 2 hours. The mixture is oxidized by performing the second heating treatment in the oxidative atmosphere. A sample of the precursor composition for the solid electrolyte obtained by oxidizing the mixture was processed into a thin piece with a FIB cross-section processing device Helios 600 manufactured by FEI Company, and the elemental distribution and formulation were examined by various analytical methods. From the observation with a transmission electron microscope (TEM) using JEM-ARM200F manufactured by JEOL Ltd. and the results of selected area electron diffraction (SAED), the sample was constituted by a relatively large amorphous region of about several hundred nm (nanometers) or more and a region of an assembly composed of nanocrystals of 30 nm or less. Further, by energy dispersive X-ray analysis (TEM-EDX) and energy loss spectroscopy (EELS) using a detector JED-2300T manufactured by JEOL Ltd., lithium (Li), carbon (C), and oxygen (O) were detected from the amorphous region of the sample, and lanthanum (La), zirconium (Zr), and the element M were detected from the region of the assembly composed of nanocrystals. Further, the precursor composition for a solid electrolyte of this embodiment shows X-ray diffraction intensity peaks at diffraction angles 2θ of 28.4°, 32.88°, 47.2°, 56.01°, and 58.73° in XRD, and therefore, it is considered that the nanocrystal has a pyrochlore-type crystal structure represented by the same space group Fd3m as La₂Zr₂O₇ and is a solid solution of La₂Zr₂O₇ and the element M. Detailed analytical results of XRD will be described in the below-mentioned section of Examples and Comparative Examples. Note that the oxidative atmosphere need only be an atmosphere containing oxygen, and examples thereof include the atmospheric air.

In order to obtain a solid electrolyte using the precursor composition for a solid electrolyte, it is necessary to perform sintering at a temperature higher than the temperature of the second heating treatment described above, and therefore, when the step of performing sintering is called “main firing”, the step of subjecting the mixture to the second heating treatment described above can be called “temporary firing”. That is, the precursor composition for a solid electrolyte obtained through the second heating treatment step is a temporarily fired body.

Specific examples of the lithium compound, the lanthanum compound, the zirconium compound, and the compound containing the element M to be used in the method for producing the precursor composition for a solid electrolyte are as follows.

Examples of the lithium compound as a lithium source include lithium metal salts such as lithium chloride, lithium nitrate, lithium acetate, lithium hydroxide, and lithium carbonate, and lithium alkoxides such as lithium methoxide, lithium ethoxide, lithium propoxide, lithium isopropoxide, lithium but oxide, lithium isobutoxide, lithium sec-butoxide, lithium tert-butoxide, and lithium dipivaloylmethanate, and among these, one type can be used or two or more types can be used in combination.

Examples of the lanthanum compound as a lanthanum source include lanthanum metal salts such as lanthanum chloride, lanthanum nitrate, and lanthanum acetate, and lanthanum alkoxides such as lanthanum trimethoxide, lanthanum triethoxide, lanthanum tripropoxide, lanthanum triisopropoxide, lanthanum tributoxide, lanthanum triisobutoxide, lanthanum tri-sec-butoxide, lanthanum tri-tert-butoxide, and lanthanum dipivaloylmethanate, and among these, one type can be used or two or more types can be used in combination.

Examples of the zirconium compound as a zirconium source include zirconium metal salts such as zirconium chloride, zirconium oxychloride, zirconium oxynitrate, zirconium oxyacetate, and zirconium acetate, and zirconium alkoxides such as zirconium tetramethoxide, zirconium tetraethoxide, zirconium tetrabutoxide, zirconium tetraisobutoxide, zirconium tetra-sec-butoxide, zirconium tetra-tert-butoxide, and zirconium dipivaloylmethanate, and among these, one type can be used or two or more types can be used in combination.

The element M is selected from Nb, Ta, and Sb. Therefore, when the element M is niobium (Nb), examples of the niobium compound as a niobium source include niobium metal salts such as niobium chloride, niobium oxychloride, and niobium oxalate, niobium alkoxides such as niobium ethoxide, niobium propoxide, niobium isopropoxide, and niobium sec-butoxide, niobium triacetylacetonate, niobium pentaacetylacetonate, and niobium diisopropoxide triacetylacetonate, and among these, one type can be used or two or more types can be used in combination.

When the element M is tantalum (Ta), examples of the tantalum compound as a tantalum source include tantalum metal salts such as tantalum chloride and tantalum bromide, and tantalum alkoxides such as tantalum pentamethoxide, tantalum pentaethoxide, tantalum pentaisopropoxide, tantalum penta-n-propoxide, tantalum pentaisobutoxide, tantalum penta-n-butoxide, tantalum penta-sec-butoxide, and tantalum penta-tert-butoxide, and among these, one type can be used or two or more types can be used in combination.

When the element M is antimony (Sb), examples of the antimony compound as an antimony source include antimony metal salts such as antimony bromide, antimony chloride, and antimony fluoride, and antimony alkoxides such as antimony trimethoxide, antimony triethoxide, antimony triisopropoxide, antimony tri-n-propoxide, antimony triisobutoxide, and antimony tri-n-butoxide, and among these, one type can be used or two or more types can be used in combination.

As the solvent that can dissolve the lithium compound, the lanthanum compound, the zirconium compound, and the compound containing the element M, water and a single solvent or a mixed solvent of an organic solvent are exemplified.

The organic solvent constituting a single solvent or a mixed solvent is not particularly limited, however, examples thereof include alcohols such as methyl alcohol, ethyl alcohol, n-propyl alcohol, isopropyl alcohol, n-butyl alcohol, allyl alcohol, and ethylene glycol monobutyl ether (2-n-butoxyethanol), glycols such as ethylene glycol, propylene glycol, butylene glycol, hexylene glycol, pentanediol, hexanediol, heptanediol, and dipropylene glycol, ketones such as dimethyl ketone, methyl ethyl ketone, methyl propyl ketone, and methyl isobutyl ketone, esters such as methyl formate, ethyl formate, methyl acetate, and methyl acetoacetate, ethers such as diethylene glycol monomethyl ether, diethylene glycol monoethyl ether, diethylene glycol dimethyl ether, ethylene glycol monomethyl ether, ethylene glycol monoethyl ether, and dipropylene glycol monomethyl ether, organic acids such as formic acid, acetic acid, 2-ethylbutyric acid, and propionic acid, aromatics such as toluene, o-xylene, and p-xylene, and amides such as formamide, N,N-dimethylformamide, N,N-diethylformamide, dimethylacetamide, and N-methylpyrrolidone.

In particular, when lithium nitrate that is a metal salt is used as the lithium compound and lanthanum nitrate that is a metal salt is used as the lanthanum compound, nitrate ions are contained in the precursor composition for a solid electrolyte. When the precursor composition for a solid electrolyte containing nitrate ions is used, the melting point of the precursor composition for a solid electrolyte is lowered, and even if the sintering temperature is set to 1000° C. or lower during sintering for obtaining a solid electrolyte, the sintering proceeds, and it becomes easy to obtain a solid electrolyte having a dense garnet-type or garnet-like crystal structure and exhibiting a high lithium ion conductivity.

Further, in order to obtain a solid electrolyte exhibiting a high lithium ion conductivity, it is preferred to select two or more types from Nb, Ta, and Sb as the element M in the precursor composition for a solid electrolyte. Details will be described in the below-mentioned section of Examples and Comparative Examples.

### 1-2. Secondary Battery

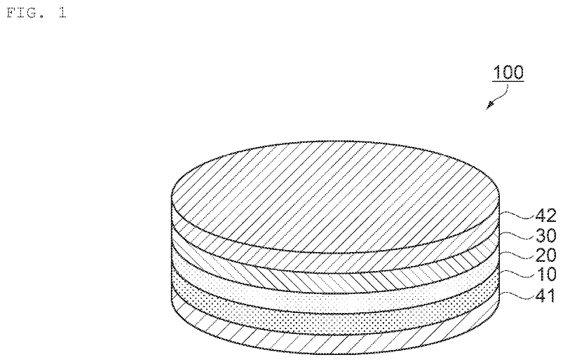

Next, a secondary battery including a solid electrolyte formed using the precursor composition for a solid electrolyte of this embodiment will be described by showing a specific example of the secondary battery. FIG. 1 is a schematic perspective view showing a configuration of a lithium-ion battery as a secondary battery of a first embodiment.

As shown in FIG. 1, a lithium-ion battery 100 as the secondary battery of this embodiment includes a positive electrode 10, and a solid electrolyte layer 20 and a negative electrode 30 sequentially stacked on the positive electrode 10. The lithium-ion battery further includes a current collector 41 in contact with the positive electrode 10 and a current collector 42 in contact with the negative electrode 30. The positive electrode 10, the solid electrolyte layer 20, and the negative electrode 30 are all constituted by a solid phase, and therefore, the lithium-ion battery 100 of this embodiment is an all-solid-state secondary battery that can be charged and discharged.

The lithium-ion battery 100 of this embodiment has, for example, a circular disk shape, and the size of the outer shape thereof is such that the diameter ϕ is, for example, from 10 to 20 mm and the thickness is, for example, about 0.3 mm (millimeters). In addition to being small and thin, the lithium-ion battery can be charged and discharged and is in an all solid state, and therefore can be favorably used as a power supply for a portable information terminal such as a smartphone. The size and the thickness of the lithium-ion battery 100 are not limited to the above values as long as it can be molded. In a case where the size of the outer shape thereof is from 10 to 20 mm ϕ as in this embodiment, the thickness from the positive electrode 10 to the negative electrode 30 is about 0.3 mm from the viewpoint of moldability when it is thin, and is up to about 1 mm estimated from the viewpoint of lithium ion conduction property when it is thick, and if it is too thick, the utilization efficiency of the active material is deteriorated. Note that the shape of the lithium-ion battery 100 is not limited to a circular disk shape, and may be a polygonal disk shape. Hereinafter, the respective configurations will be described.

### 1-2-1. Solid Electrolyte Layer

The solid electrolyte layer 20 in the lithium-ion battery 100 of this embodiment is formed using the precursor composition for a solid electrolyte of this embodiment. The thickness of the solid electrolyte layer 20 is preferably set within a range from 300 nm (nanometers) to 1000 μm (micrometers), and more preferably set to 500 nm to 100 μm from the viewpoint of charge-discharge rate. Further, from the viewpoint of preventing a short circuit between the positive electrode 10 and the negative electrode 30 due to a lithium dendritic crystal body (dendrite) deposited at the negative electrode 30 side, a mass ratio of the solid electrolyte to the total volume of the solid electrolyte layer 20, that is, the theoretical bulk density is preferably set to 50% or more, more preferably set to 90% or more. As a method for forming such a solid electrolyte layer 20, a green sheet method, a press sintering method, a cast sintering method, or the like is exemplified, and the method can be selected in consideration of desired thickness, size, and productivity. A specific example of the method for forming the solid electrolyte layer 20 will be described later. Note that for the purpose of improving the adhesion of the solid electrolyte layer 20 to the positive electrode 10 and the negative electrode 30, or improving the output or battery capacity of the lithium-ion battery 100 by an increase in specific surface area, or the like, a three-dimensional pattern structure of a dimple, a trench, a pillar, or the like may be formed at a surface of the solid electrolyte layer 20 that comes in contact with the positive electrode 10 or the negative electrode 30.

### 1-2-2. Positive Electrode

As the positive electrode 10 in the lithium-ion battery 100 of this embodiment, any may be used as long as it is a positive electrode active material that can repeat electrochemical occlusion and release of lithium ions. As a specific positive electrode active material, a lithium composite oxide which contains at least lithium (Li) and is constituted by any one or more types of elements selected from the group consisting of vanadium (V), chromium (Cr), manganese (Mn), iron (Fe), cobalt (Co), nickel (Ni), and copper (Cu) can be used. Examples of such a composite oxide include LiCoO₂, LiNiO₂, LiMn₂O₄, Li₂Mn₂O₃, LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄. Further, for example, a fluoride such as LiFeF₃, a boride complex compound such as LiBH₄ or Li₄BN₃H₁₀, an iodine complex compound such as a polyvinylpyridine-iodine complex, or a nonmetallic compound such as sulfur can also be used as the positive electrode active material.

The positive electrode 10 is desirably formed into a thin film with a thickness of 100 nm to 500 μm at a surface of the solid electrolyte layer 20 in any case in consideration of an electric conduction property and an ion diffusion distance, and more preferably has a thickness of 300 nm to 100 μm.

As a method for forming such a positive electrode 10, various methods can be selected according to the physicochemical properties, desired thickness, area, and productivity of the positive electrode active material, or the like as long as it is a method capable of forming a thin film having the favorable thickness described above. Specifically, a method such as a vapor phase deposition method such as a vacuum vapor deposition method, a sputtering method, a CVD method, a PLD method, an ALD method, or an aerosol deposition method, or a chemical deposition method using a solution such as a sol-gel method or an MOD method can be exemplified. In addition, fine particles of the positive electrode active material are formed into a slurry together with an appropriate binder, followed by squeegeeing or screen printing, thereby forming a coating film, and then, the coating film may be baked onto the surface of the solid electrolyte layer 20 by drying and sintering.

### 1-2-3. Negative Electrode

As the negative electrode 30, any may be used as long as it is a so-called negative electrode active material that repeats electrochemical occlusion and release of lithium ions at a lower potential than the material selected as the positive electrode. As a specific negative electrode active material, Nb₂O₅, V₂O₅, TiO₂, In₂O₃ (indium oxide), ZnO (zinc oxide), SnO₂ (tin oxide), NiO, ITO (indium oxide doped with Sn), AZO (zinc oxide doped with aluminum), GZO (zinc oxide doped with gallium), ATO (tin oxide doped with antimony), FTO (tin oxide doped with fluoride), and lithium composite oxides such as Li₄Ti₅O₁₂ and Li₂Ti₃O₇ are exemplified. Further, metals and alloys such as Li, Al, Si, Si—Mn, Si—Co, Si—Ni, Sn, Zn, Sb, Bi, In, and Au, carbon materials, and materials obtained by intercalation of lithium ions between layers of a carbon material (such as LiC₂₄ and LiC₆), and the like are exemplified, and among these, one or more types are selected. The negative electrode 30 is desirably formed into a thin film with a thickness of 100 nm to 500 μm at a surface of the solid electrolyte layer 20 in any case in consideration of an electric conduction property and an ion diffusion distance, and more preferably has a thickness of 300 nm to 100 μm.

As a method for forming such a negative electrode 30, various methods can be selected according to the physicochemical properties, desired thickness, area, and productivity of the negative electrode active material, or the like as long as it is a method capable of forming a thin film having the favorable thickness described above. Specifically, a method such as a vapor phase deposition method such as a vacuum vapor deposition method, a sputtering method, a CVD method, a PLD method, an ALD method, or an aerosol deposition method, or a chemical deposition method using a solution such as a sol-gel method or an MOD method can be exemplified. In addition, fine particles of the negative electrode active material are formed into a slurry together with an appropriate binder, followed by squeegeeing or screen printing, thereby forming a coating film, and then, the coating film may be baked onto the surface of the solid electrolyte layer 20 by drying and sintering.

### 1-2-4. Current Collector

The current collector is an electric conductor provided so as to play a role in transfer of electrons to the positive electrode 10 or the negative electrode 30, and a material that has a sufficiently small electrical resistance and does not change the electric conduction property or the mechanical structure thereof by charging and discharging is selected. Specifically, for the current collector 41 of the positive electrode 10, aluminum (Al), titanium (Ti), platinum (Pt), gold (Au), or the like is used. Further, for the current collector 42 of the negative electrode 30, copper (Cu) is favorably used. The current collectors 41 and 42 are provided so that the contact resistance with the positive electrode 10 or the negative electrode 30 becomes small, and those having various forms can be selected according to the design of the lithium-ion battery 100 such as a plate shape or a mesh shape. In this embodiment, the lithium-ion battery 100 is configured to include a pair of current collectors 41 and 42, however, for example, when a plurality of lithium-ion batteries 100 are used by being stacked and electrically coupled to one another in series, the lithium-ion battery 100 may also be configured to include only the current collector 41 of the pair of current collectors 41 and 42.

### 1-3. Method for Producing Secondary Battery

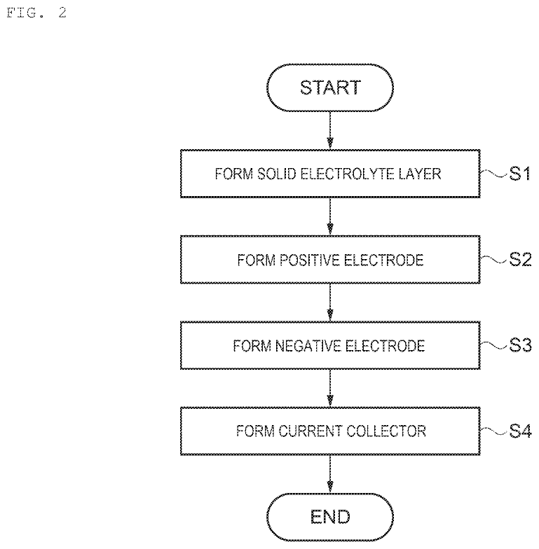

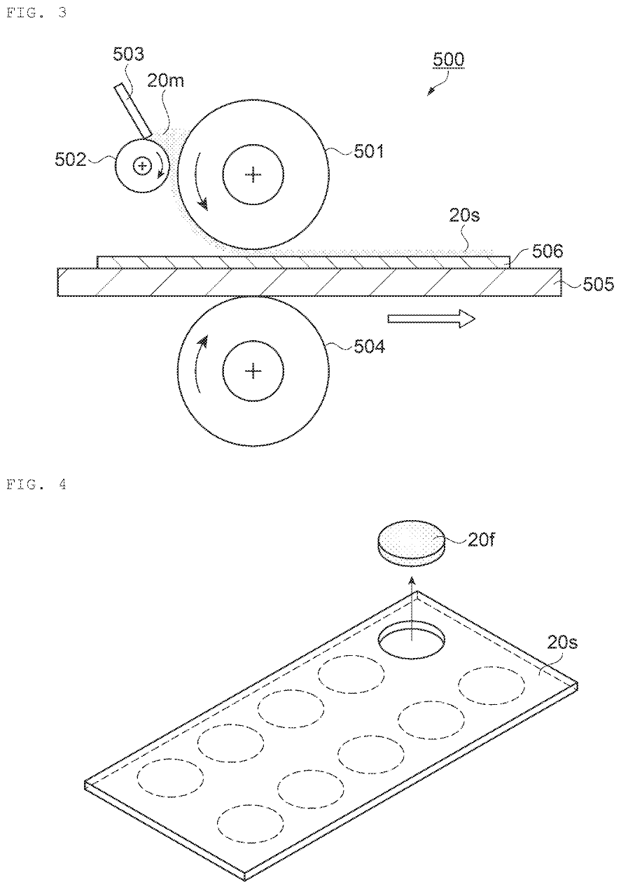

Next, a method for producing the lithium-ion battery as the secondary battery of this embodiment will be described by showing a specific example. FIG. 2 is a flowchart showing a method for producing the lithium-ion battery as the secondary battery of the first embodiment, and FIGS. 3 and 4 are each a schematic view showing the method for producing the lithium-ion battery as the secondary battery of the first embodiment.

As shown in FIG. 2, the method for producing the lithium-ion battery 100 of this embodiment includes a step of forming the solid electrolyte layer 20 (Step S1), a step of forming the positive electrode 10 (Step S2), a step of forming the negative electrode 30 (Step S3), and a step of forming the current collectors 41 and 42 (Step S4).

In the step of forming the solid electrolyte layer 20 of Step S1, the solid electrolyte layer 20 is formed by, for example, a green sheet method using the precursor composition for a solid electrolyte of this embodiment. Specifically, a solution in which 10 g of polypropylene carbonate (manufactured by Sigma-Aldrich Co. LLC.) as a binder of a green sheet was dissolved in 40 g of 1,4-dioxane (manufactured by Kanto Chemical Co., Inc.) was prepared, and further 15 g of the precursor composition for a solid electrolyte of this embodiment was added thereto and mixed, whereby a slurry was formed. To a slurry 20m, a dispersant, a diluent, a humectant, or the like may be added as needed. Subsequently, by using the slurry 20m, a solid electrolyte mixture sheet 20s is formed. Specifically, as shown in FIG. 3, for example, by using a fully automatic film applicator 500 (manufactured by Cortec Corporation), the slurry 20m is applied to a predetermined thickness onto a base material 506 such as a polyethylene terephthalate (PET) film, whereby the solid electrolyte mixture sheet 20s is formed. The fully automatic film applicator 500 includes an application roller 501 and a doctor roller 502. A squeegee 503 is provided so as to come in contact with the doctor roller 502 from above. A conveyance roller 504 is provided below the application roller 501 at a position opposite thereto, and a stage 505 on which the base material 506 is placed is conveyed in a fixed direction by inserting the stage 505 between the application roller 501 and the conveyance roller 504. The slurry 20m is fed to a side where the squeegee 503 is provided between the application roller 501 and the doctor roller 502 disposed with a gap therebetween in the conveyance direction of the stage 505. The slurry 20m with a constant thickness is applied to the surface of the application roller 501 by rotating the application roller 501 and the doctor roller 502 so as to extrude the slurry 20m downward from the gap. Then, by rotating the conveyance roller 504 at the same time, the stage 505 is conveyed so that the base material 506 comes in contact with the application roller 501 to which the slurry 20m has been applied. By doing this, the slurry 20m applied to the application roller 501 is transferred in a sheet form to the base material 506, whereby the solid electrolyte mixture sheet 20s is formed. In this embodiment, 2.5 g of the above-mentioned slurry 20m was weighed and fed to the fully automatic film applicator 500 (manufactured by Cortec Corporation), and the solid electrolyte mixture sheet 20s having a width of 5 cm, a length of 10 cm, and a thickness of 20 μm was formed on the base material 506. The solid electrolyte mixture sheet 20s formed on the base material 506 was dried in the air for 8 hours and detached from the base material 506, and as shown in FIG. 4, a molded material 20f having a diameter ϕ of 2 cm was formed using a punching die. Subsequently, the molded material 20f was sintered at 900° C. for 8 hours in an oxidative atmosphere, whereby the solid electrolyte layer 20 having a diameter ϕ of about 19 mm and a thickness of 16 μm was obtained. Note that the solid electrolyte mixture sheet 20s having a constant thickness is formed by pressing and extruding the slurry 20m with the application roller 501 and the doctor roller 502 so that the theoretical bulk density of the solid electrolyte layer 20 after sintering becomes 90% or more. Then, the process proceeds to Step S2.

In the step of forming the positive electrode 10 of Step S2, the positive electrode 10 is formed at one face of the solid electrolyte layer 20. Specifically, by using a sputtering device SSP2000 manufactured by Suga Works Co., Ltd., a LiCoO₂ layer was formed at a surface of the solid electrolyte layer 20 having a diameter ϕ of 19 mm by sputtering using lithium cobalt oxide (LiCoO₂) having a diameter ϕ of 4.9 cm manufactured by Toshima Manufacturing Co., Ltd. as a target. Argon gas was used as the carrier gas. After sputtering, the solid electrolyte layer 20 at which the LiCoO₂ layer was formed was fired at 500° C. for 2 hours in an oxidative atmosphere to convert the crystal of the LiCoO₂ layer to a high-temperature phase crystal, whereby the positive electrode 10 having a thickness of 5.4 μm was obtained. Then, the process proceeds to Step S3.

In the step of forming the negative electrode 30 of Step S3, the negative electrode 30 is formed at the other face of the solid electrolyte layer 20. Specifically, by using a glove box storage type vacuum vapor deposition device manufactured by Kenix Co., Ltd., the negative electrode 30 was formed by forming a thin film of metal Li having a film thickness of, for example, 20 μm at a face of the solid electrolyte layer 20 at an opposite side from the face at which the positive electrode 10 was formed. Then, the process proceeds to step S4.

In the step of forming the current collectors 41 and 42 of Step S4, the current collector 41 was formed so as to come in contact with the positive electrode 10, and the current collector 42 was formed so as to come in contact with the negative electrode 30. Specifically, an aluminum foil having a thickness of 40 μm punched to a diameter ϕ of 15 mm was joined to the positive electrode 10 by pressing, whereby the current collector 41 was formed. Further, a copper foil having a thickness of 20 μm punched to a diameter ϕ of 15 mm was joined to the negative electrode 30 by pressing, whereby the current collector 42 was formed. As described above, in the lithium-ion battery 100, the pair of current collectors 41 and 42 is not an essential component, and the step of forming a current collector may be configured to form one of the pair of current collectors 41 and 42.

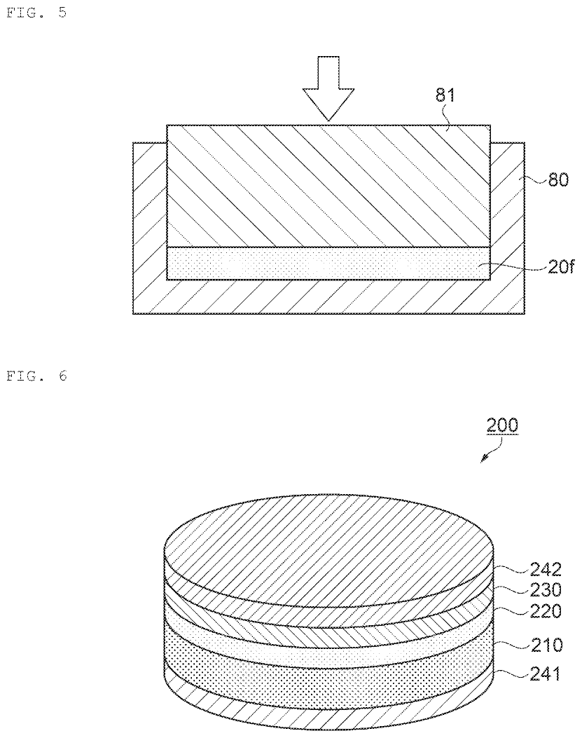

Note that the method for forming the solid electrolyte layer 20 is not limited to the green sheet method shown in Step S1. FIG. 5 is a schematic cross-sectional view showing another method for forming a solid electrolyte layer. As another method for forming the solid electrolyte layer 20, for example, as shown in FIG. 5, 1200 mg of a powder of the precursor composition for a solid electrolyte of this embodiment is weighed and filled in a pellet die 80 with an exhaust port made of stainless steel having an inner diameter ϕ of 20 mm manufactured by Specac, Inc., and the pellet die is closed with a lid 81. The lid 81 is pressed with a pressure of 300 MPa to perform uniaxial press molding for 2 minutes, whereby a molded material 20f is obtained. The molded material 20f was taken out from the pellet die 80 and sintered at 900° C. for 8 hours in an oxidative atmosphere, whereby the solid electrolyte layer 20 having a diameter ϕ of 19 mm and a thickness of 80 μm was obtained. The theoretical bulk density of the solid electrolyte layer 20 at that time was 92%. The theoretical bulk density is the ratio of the actual mass to the theoretical mass based on the apparent volume.

It is preferred that the theoretical bulk density of the solid electrolyte layer 20 provided between the positive electrode 10 and the negative electrode 30 is as high as possible as described above. For example, a solid electrolyte obtained by the above-mentioned forming method is ground using an agate mortar, and a mixture obtained by adding 400 mg of a powder of the precursor composition for a solid electrolyte of this embodiment to 800 mg of the obtained powder of the solid electrolyte is filled in the pellet die 80, and the pellet die is covered with the lid 81, and uniaxial press molding is performed for 2 minutes by pressing with a pressure of 300 MPa, whereby a molded material 20f is obtained. The molded material 20f was taken out from the pellet die 80 and sintered at 900° C. for 8 hours in an oxidative atmosphere, whereby the solid electrolyte layer 20 having a diameter ϕ of 19.8 mm and a thickness of 87 μm was obtained. The theoretical bulk density of the solid electrolyte layer 20 at that time was 97%.

According to the above-mentioned first embodiment, the following effects are obtained.

1) The precursor composition for a solid electrolyte of this embodiment is a precursor composition for a garnet-type or garnet-like solid electrolyte containing Li, La, Zr, and M, wherein the element M is one or more types selected from Nb, Ta, and Sb, the compositional ratio of Li:La:Zr:element M in the solid electrolyte is 7-x:3:2-x:x, a relationship of 0<x<2.0 is satisfied, and the precursor composition exhibits X-ray diffraction intensity peaks at diffraction angles 2θ of 28.4°, 32.88°, 47.2°, 56.01°, and 58.73° in an X-ray diffraction pattern. Such a precursor composition for a solid electrolyte has an amorphous region containing Li, C, and O, and a region of an assembly composed of nanocrystals considered to be a solid solution of La₂Zr₂O₇ and the element M. Further, such a precursor composition for a solid electrolyte is obtained by mixing raw material solutions prepared by dissolving each of the raw material compounds containing the constituent elements of the solid electrolyte in a solvent, followed by drying and firing. Therefore, as compared to a case where powders of raw material compounds containing the constituent elements of the solid electrolyte are mixed based on the stoichiometric formulation of the compositional formula (1) of the solid electrolyte and the resulting mixture is sintered, sintering of the oxide easily proceeds even if the temperature in the sintering is lowered to 1000° C. or lower. According to this, a change in the formulation due to volatilization of lithium during sintering is suppressed, and a garnet-type or garnet-like solid electrolyte having a high lithium ion conductivity can be achieved. A solid electrolyte formed using the precursor composition for a solid electrolyte of this embodiment is represented by the following compositional formula (1).

Li₇₋ₓLa₃(Zr₂₋ₓ,Mₓ)O₁₂ (1)

In the above compositional formula (1), as the element M, one or more types are selected from Nb, Ta, and Sb, and x satisfies 0<x<2.0.

2) When producing the precursor composition for a solid electrolyte of this embodiment, by using lithium nitrate as the lithium compound and lanthanum nitrate as the lanthanum compound, nitrate ions are contained in the obtained precursor composition for a solid electrolyte. As compared to a case where an alkoxide is used as the lithium compound or the lanthanum compound, the heating temperature during sintering can be lowered to a temperature lower than 1000° C. This is considered to be due to the lowering of the melting point of the precursor composition fora solid electrolyte by containing nitrate ions.

3) In the precursor composition for a solid electrolyte of this embodiment, it is preferred that the element M is two or more types selected from Nb, Ta, and Sb. According to this, by selecting two or more types from Nb, Ta, and Sb as the element M that partially substitutes the Zr sites, in the solid electrolyte represented by the above compositional formula (1), a higher lithium ion conductivity can be achieved.

4) In the method for producing the lithium-ion battery 100 as the secondary battery of this embodiment, the solid electrolyte layer 20 having a high lithium ion conductivity is formed using the precursor composition for a solid electrolyte of this embodiment, and therefore, the lithium-ion battery 100 having excellent charge-discharge characteristics can be produced.

### 2. SECOND EMBODIMENT

### 2-1. Secondary Battery

Next, another example of the secondary battery including the solid electrolyte formed using the precursor composition for a solid electrolyte of this embodiment will be described by showing a lithium-ion battery as an example in the same manner as the above-mentioned first embodiment.

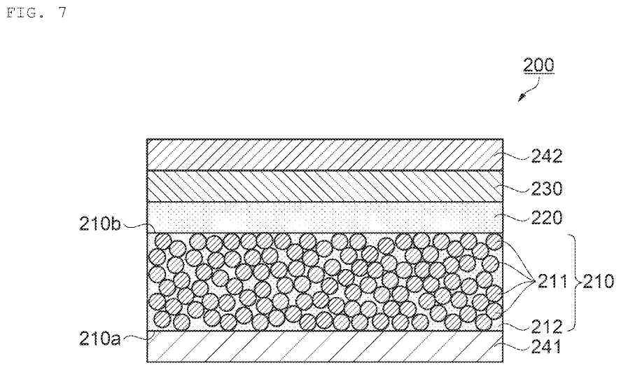

FIG. 6 is a schematic perspective view showing a configuration of a lithium-ion battery as a secondary battery of a second embodiment, and FIG. 7 is a schematic cross-sectional view showing a structure of the lithium-ion battery as the secondary battery of the second embodiment.

As shown in FIG. 6, a lithium-ion battery 200 as the secondary battery of this embodiment includes a positive electrode composite material 210 that functions as a positive electrode, and an electrolyte layer 220 and a negative electrode 230, which are sequentially stacked on the positive electrode composite material 210. Further, the lithium-ion battery includes a current collector 241 in contact with the positive electrode composite material 210 and a current collector 242 in contact with the negative electrode 230.

The positive electrode composite material 210, the solid electrolyte layer 220, and the negative electrode 230 are all constituted by a solid phase, and therefore, the lithium-ion battery 200 of this embodiment is also an all-solid-state secondary battery that can be charged and discharged.

The lithium-ion battery 200 of this embodiment has, for example, a circular disk shape, and the size of the outer shape thereof is such that the diameter ϕ is, for example, from 10 to 20 mm and the thickness is, for example, about 0.3 mm (millimeters). In addition to being small and thin, the lithium-ion battery can be charged and discharged and is in an all solid state, and therefore can be favorably used as a power supply for a portable information terminal such as a smartphone. The size and the thickness of the lithium-ion battery 200 are not limited to the above values as long as it can be molded. In a case where the size of the outer shape thereof is from 10 to 20 mm ϕ as in this embodiment, the thickness from the positive electrode composite material 210 to the negative electrode 230 is about 0.3 mm from the viewpoint of moldability when it is thin, and is up to about 1 mm estimated from the viewpoint of lithium ion conduction property when it is thick, and if it is too thick, the utilization efficiency of the active material is deteriorated. Note that the shape of the lithium-ion battery 200 is not limited to a circular disk shape, and may be a polygonal disk shape. Hereinafter, the respective configurations will be described in detail.

### 2-1-1. Positive Electrode Composite Material

As shown in FIG. 7, the positive electrode composite material 210 in the lithium-ion battery 200 of this embodiment is configured to include a positive electrode active material 211 in a particulate shape and a solid electrolyte 212. In such a positive electrode composite material 210, the battery reaction rate in the lithium-ion battery 200 can be increased by increasing an interfacial area where the positive electrode active material 211 in a particulate shape and the solid electrolyte 212 are in contact with each other.

As the positive electrode active material 211 to be used for the positive electrode composite material 210, it is preferred to adopt a material in a particulate shape having a particle diameter of 100 nm to 100 μm, and it is more preferred to adopt a material having a particle diameter of 300 nm to 30 μm. Here, the particle diameter represents the maximum diameter of the particle of the positive electrode active material 211. Note that in FIG. 7, the shape of the positive electrode active material 211 in a particulate shape is shown as a spherical shape, however, the shape of the positive electrode active material 211 is not limited to the spherical shape, and it is considered that the material has various shapes such as a columnar shape, a plate shape, and a hollow shape, but actually the material has an indefinite shape. Therefore, the particle diameter of the positive electrode active material 211 in a particulate shape is sometimes represented as an average particle diameter.

As such a positive electrode active material 211, as described in the above first embodiment, a lithium composite oxide which contains at least lithium (Li) and is constituted by any one or more types of elements selected from the group consisting of vanadium (V), chromium (Cr), manganese (Mn), iron (Fe), cobalt (Co), nickel (Ni), and copper (Cu) can be used. Examples of such a composite oxide include LiCoO₂, LiNiO₂, LiMn₂O₄, Li₂Mn₂O₃, LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄. Further, for example, a fluoride such as LiFeF₃, a lithium borohydride compound that is a complex hydride such as LiBH₄ or Li₄BN₃H₁₀, an iodine complex compound such as a polyvinylpyridine-iodine complex, or a nonmetallic compound such as sulfur can also be used as the positive electrode active material 211.

Further, in the particle of the positive electrode active material 211, a coating layer or the like may be formed at a surface for the purpose of reducing the interfacial resistance with the solid electrolyte 212, or improving the electron conduction property, or the like. For example, by forming a thin film of LiNbO₃, Al₂O₃, ZrO₂, Ta₂O₅, or the like to about 3 nm to 1 μm at a surface of the particle of the positive electrode active material 211 composed of LiCoO₂, the interfacial resistance of lithium ion conduction can be reduced.

Further, the positive electrode composite material 210 is combined with an electrolyte, an electric conduction assistant, a binder, or the like other than the positive electrode active material 211 according to a required property or design. In this embodiment, the solid electrolyte 212 included in the positive electrode composite material 210 is formed using the precursor composition for a solid electrolyte of this embodiment from the viewpoint of an ion conduction property, chemical stability, and an interfacial impedance with the electrolyte layer 220.

That is, the solid electrolyte 212 is represented by the following compositional formula (1).

Li₇₋ₓLa₃(Zr₂₋ₓ,Mₓ)O₁₂ (1)

In the above compositional formula (1), as the element M, one or more types are selected from Nb, Ta, and Sb, and x satisfies 0<x<2.0.

As the electric conduction assistant, any may be used as long as it is an electric conductor whose electrochemical interaction can be ignored at a positive electrode reaction potential. A carbon material such as acetylene black, Ketjen black, or a carbon nanotube, a noble metal such as palladium or platinum, an electrically conductive oxide such as SnO₂, ZnO, RuO₂, ReO₃, or Ir₂O₃ can be used.

### 2-1-2. Electrolyte Layer

The electrolyte layer 220 is preferably constituted by the same material as the solid electrolyte 212 from the viewpoint of an interfacial impedance with the positive electrode composite material 210, but a crystalline material or an amorphous material of another oxide solid electrolyte, a sulfide solid electrolyte, a nitride solid electrolyte, a halide solid electrolyte, a hydride solid electrolyte, a dry polymer electrolyte, or a quasi-solid electrolyte can also be used by being mixed or by itself.

Examples of a crystalline oxide include Li_{0.35}La_{0.55}TiO₃, Li_{0.2}La_{0.27}NbO₃, and a perovskite-type crystal or a perovskite-like crystal in which the elements of a crystal thereof are partially substituted with N, F, Al, Sr, Sc, Nb, Ta, Sb, a lanthanoid element, or the like, Li₇La₃Zr₂O₁₂, Li₅La₃Nb₂O₁₂, Li₅BaLa₂TaO₁₂, and a garnet-type crystal or a garnet-like crystal in which the elements of a crystal thereof are partially substituted with N, F, Al, Sr, Sc, Nb, Ta, Sb, a lanthanoid element, or the like, Li_{1.3}Ti_{1.7}Al_{0.3}(PO₄)₃, Li_{1.4}Al_{0.4}Ti_{1.6}(PO₄)₃, Li_{1.4}Al_{0.4} Ti_{1.4}Ge_{0.2} (PO₄)₃, and a NASICON-type crystal in which a crystal thereof is partially substituted with N, F, Al, Sr, Sc, Nb, Ta, Sb, a lanthanoid element, or the like, a LISICON-type crystal such as Li₁₄ZnGe₄O₁₆, and other crystalline materials such as Li_{3.4}V_{0.6}Si_{0.4}O₄, Li_{3.6}V_{0.4}Ge_{0.6}O₄, and Li₂₊ₓC₁₋ₓBₓO₃.

Examples of a crystalline sulfide include Li₁₀GeP₂S₁₂, Li_{9.6}P₃S₁₂, Li_{9.54}Si_{1.74}P_{1.44}S_{11.7}C_{10.3}, and Li₃PS₄.

Further, examples of other amorphous materials include Li₂O—TiO₂, La₂O₃—Li₂O—TiO₂, LiNbO₃, LiSO₄, Li₄SiO₄, Li₃PO₄—Li₄SiO₄, Li₄GeO₄—Li₃VO₄, Li₄SiO₄—Li₃VO₄, Li₄GeO₄—Zn₂GeO₂, Li₄SiO₄—LiMoO₄, Li₄SiO₄—Li₄ZrO₄, SiO₂—P₂O₅—Li₂O, SiO₂—P₂₀₅—LiCl, Li₂O—LiCl—B₂O₃, LiAlCl₄, LiAlF₄, LiF—Al₂O₃, LiBr—Al₂O₃, Li_{2.88}PO_{3.73}N_{0.14}, Li₃N—LiCl, Li₆NBr₃, Li₂S—SiS₂, and Li₂S—SiS₂P₂S₅.

In the case of a crystalline material, the crystalline material preferably has a crystal structure such as a cubic crystal having small crystal plane anisotropy in the direction of lithium ion conduction. Further, in the case of an amorphous material, the anisotropy in lithium ion conduction is small, and therefore, such a crystalline material or an amorphous material is each preferred as a solid electrolyte constituting the electrolyte layer 220.

The thickness of the electrolyte layer 220 is preferably 0.1 μm or more and 100 μm or less, and more preferably 0.2 μm or more and 10 μm or less. By setting the thickness of the electrolyte layer 220 within the above range, the internal resistance of the electrolyte layer 220 can be decreased, and also the occurrence of a short circuit between the positive electrode composite material 210 and the negative electrode 230 can be suppressed.

Note that in the face that comes in contact with the negative electrode 230 of the electrolyte layer 220, a three-dimensional pattern structure of a dimple, a trench, a pillar, or the like may be formed by combining various molding methods or processing methods as needed.

### 2-1-3. Negative Electrode

The negative electrode 230 can adopt the same configuration as that of the negative electrode 30 in the lithium-ion battery 100 of the first embodiment described above. Therefore, the detailed description will be omitted here.

### 2-1-4. Current Collector

The current collector is an electric conductor provided so as to play a role in transfer of electrons to the positive electrode composite material 210 or the negative electrode 230, and a material that has a sufficiently small electrical resistance and does not change the electric conduction property or the mechanical structure thereof by charging and discharging is selected. Therefore, the current collector 241 in contact with the positive electrode composite material 210 and the current collector 242 in contact with the negative electrode 230 can adopt the same configuration as that of the current collectors 41 and 42 in the lithium-ion battery 100 of the first embodiment described above. Therefore, the detailed description will be omitted here. Note that in the lithium-ion battery 200, the pair of current collectors 241 and 242 is not essential, and a configuration in which only one of them is included may be adopted.

### 2-2. Method for Producing Secondary Battery

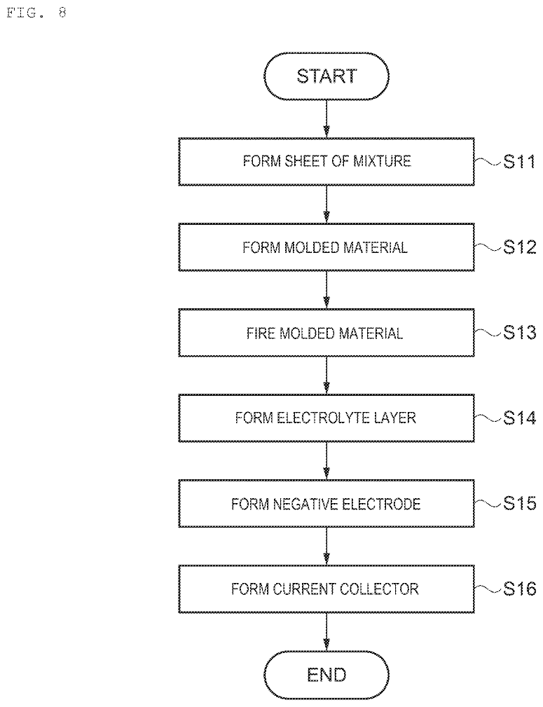

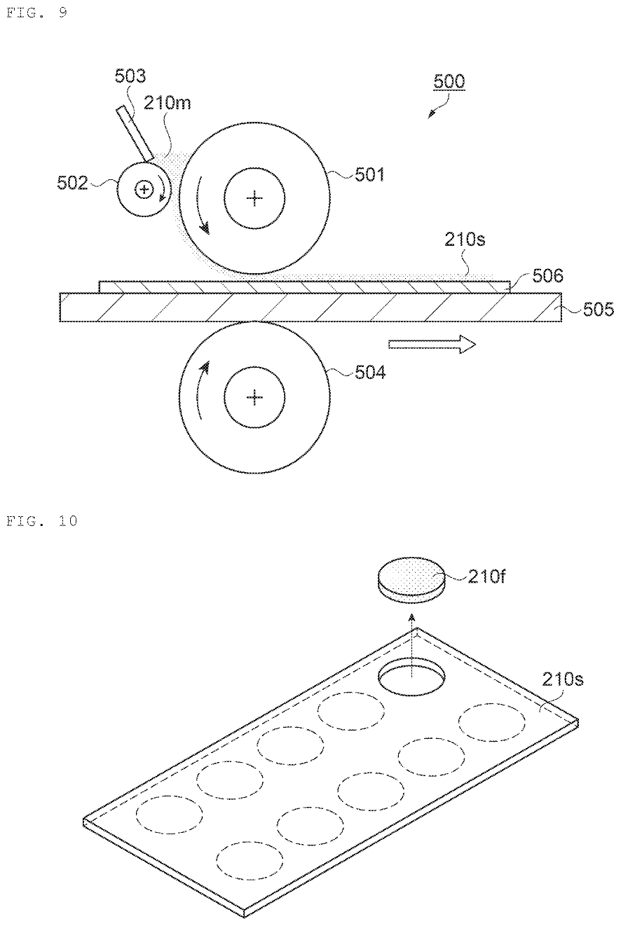

Next, a method for producing the lithium-ion battery as the secondary battery of this embodiment will be described by showing a specific example. FIG. 8 is a flowchart showing a method for producing the lithium-ion battery as the secondary battery of the second embodiment, and FIGS. 9 and 10 are each a schematic view showing the method for producing the lithium-ion battery as the secondary battery of the second embodiment.

As shown in FIG. 8, the method for producing the lithium-ion battery 200 of this embodiment includes a step of forming a sheet of a mixture (Step S11), a step of forming a molded material (Step S12), a step of firing the molded material (Step S13), a step of forming the electrolyte layer 220 (Step S14), a step of forming the negative electrode 230 (Step S15), and a step of forming the current collectors 241 and 242 (Step S16).

In the step of forming a sheet of a mixture of Step S11, 15 g of a LiCoO₂ powder manufactured by Nippon Kayaku Co., Ltd. having an average particle diameter of 5 μm as the positive electrode active material 211, 18 g of a powder of the precursor composition for a solid electrolyte of this embodiment, and g of polypropylene carbonate (PPC) manufactured by Sigma-Aldrich Co. LLC. as a binder are mixed in 90 g of 1,4-dioxane that is a solvent manufactured by Kanto Chemical Co., Inc. and formed into a slurry by mixing. Then, as shown in FIG. 9, the obtained slurry 210m was fed to a fully automatic film applicator 500 and applied onto a base material 506, whereby a positive electrode composite material mixture sheet 210s having a width of 5 cm, a length of 10 cm, and a thickness of 70 μm was obtained. Then, the process proceeds to Step S12.

In the step of forming a molded material of Step S12, the positive electrode composite material mixture sheet 210s was dried in the air for 8 hours, and the positive electrode composite material mixture sheet 210s was detached from the base material 506, and as shown in FIG. 10, a molded material 210f having a diameter ϕ of 20 mm was obtained by punching. Then, the process proceeds to Step S13.

In the step of firing the molded material of Step S13, the molded material 210f was sintered at 900° C. for 8 hours in an oxidative atmosphere, whereby the positive electrode composite material 210 was obtained. Then, the process proceeds to Step S14.

In the step of forming the electrolyte layer 220 of Step S14, the electrolyte layer 220 was formed at one face 210b (see FIG. 7) of the positive electrode composite material 210. Specifically, by using a sputtering device SSP2000 (manufactured by Suga Works Co., Ltd.), the electrolyte layer 220 was formed by forming a Li_{2.2}C_{0.8}B_{0.2}O₃ layer at the one face 210b (see FIG. 7) of the positive electrode composite material 210 using a solid solution Li_{2.2}C_{0.8}B_{0.2}O₃ (manufactured by Toshima Manufacturing Co., Ltd.) of Li₂CO₃ and Li₃BO₃ having a diameter ϕ of 4.9 cm as a target. A portion of the positive electrode composite material 210 after sputtering was analyzed with a field-emission surface scanning electron microscope XL30FEG manufactured by Royal Philips, it was found that a Li_{2.2}C_{0.8}B_{0.2}O₃ layer having a thickness of 5.6 μm was formed. Then, the process proceeds to Step S15.

In the step of forming the negative electrode 230 of Step S15, the negative electrode 230 was formed at the one face 210b side of the positive electrode composite material 210. Specifically, by using a glove box storage type vacuum vapor deposition device manufactured by Kenix Co., Ltd., the negative electrode 230 was formed by forming a thin film of metal Li having a film thickness of, for example, 20 μm at a face of the solid electrolyte layer 220 at an opposite side from the positive electrode composite material 210. Then, the process proceeds to step S16.

In the step of forming the current collectors 241 and 242 of Step S16, the current collector 241 was formed so as to come in contact with the other face 210a of the positive electrode composite material 210, and the current collector 242 was formed so as to come in contact with the negative electrode 230. Specifically, an aluminum foil having a thickness of 40 μm punched to a diameter ϕ of 15 mm was joined to the positive electrode composite material 210 by pressing, whereby the current collector 241 was formed. Further, a copper foil having a thickness of 20 μm punched to a diameter ϕ of 15 mm was joined to the negative electrode 230 by pressing, whereby the current collector 242 was formed. Note that the step of forming a current collector may be configured to form only one of the pair of current collectors 241 and 242.

Further, the method for forming the positive electrode composite material 210 and the electrolyte layer 220 is not limited to the method shown in Step S11 to Step S14. For example, the following method may be adopted. 15 g of a powder of the precursor composition for a solid electrolyte of this embodiment and 10 g of PPC as a binder are mixed in 40 g of 1,4-dioxane that is a solvent and formed into a slurry by mixing. Then, the obtained slurry is fed to the fully automatic film applicator 500 and applied onto the base material 506, whereby an electrolyte mixture sheet having a width of 5 cm, a length of 10 cm, and a thickness of 20 μm is formed. In Step S12, the positive electrode composite material mixture sheet 210s detached from the base material 506 and the electrolyte mixture sheet are stacked and bonded to each other by roll pressing at 90° C. with a pressure of 4 MPa. The stacked sheet obtained by bonding is punched to form a molded material, and the molded material is sintered at 900° C. for 8 hours in an oxidative atmosphere, whereby a stacked body of the positive electrode composite material 210 and the electrolyte layer 220 is obtained.

According to the method for producing the lithium-ion battery 200 as the secondary battery of the second embodiment described above, the following effect is obtained.

The positive electrode composite material 210 is formed by sintering a mixture obtained by mixing the positive electrode active material 211 in a particulate shape and a powder of the precursor composition for a solid electrolyte of this embodiment. Therefore, the positive electrode composite material 210 is configured to include the positive electrode active material 211 in a particulate shape and the solid electrolyte 212 represented by the following compositional formula (1), so that the lithium-ion battery 200, in which lithium ions are smoothly conducted at an interface between the positive electrode active material 211 in a particulate shape and the solid electrolyte 212, and which has excellent charge-discharge characteristics can be produced.

Li₇₋ₓLa₃(Zr₂₋ₓ,Mₓ)O₁₂ (1)

In the above compositional formula (1), as the element M, one or more types are selected from Nb, Ta, and Sb, and x satisfies 0<x<2.0.

### 3. THIRD EMBODIMENT

### 3-1. Secondary Battery

Next, another example of the secondary battery including the solid electrolyte formed using the precursor composition for a solid electrolyte of this embodiment will be described by showing a lithium-ion battery as an example in the same manner as the above-mentioned first embodiment.

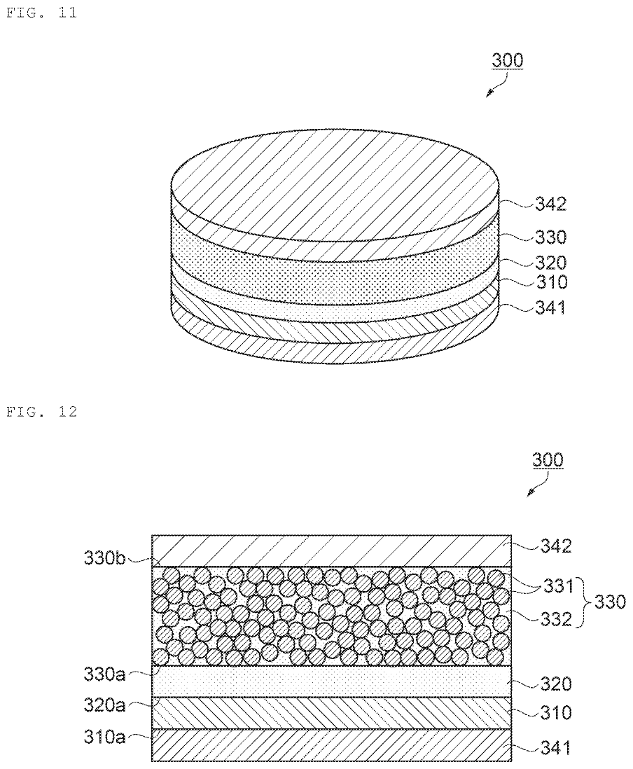

FIG. 11 is a schematic perspective view showing a configuration of a lithium-ion battery as a secondary battery of a third embodiment, and FIG. 12 is a schematic cross-sectional view showing a structure of the lithium-ion battery as the secondary battery of the third embodiment.

As shown in FIG. 11, a lithium-ion battery 300 as the secondary battery of this embodiment includes a positive electrode 310, and an electrolyte layer 320 and a negative electrode composite material 330 that functions as a negative electrode, which are sequentially stacked on the positive electrode 310. Further, the lithium-ion battery includes a current collector 341 in contact with the positive electrode 310 and a current collector 342 in contact with the negative electrode composite material 330.

The positive electrode 310, the solid electrolyte layer 320, and the negative electrode composite material 330 are all constituted by a solid phase, and therefore, the lithium-ion battery 300 of this embodiment is also an all-solid-state secondary battery that can be charged and discharged.

The lithium-ion battery 300 of this embodiment has, for example, a circular disk shape, and the size of the outer shape thereof is such that the diameter ϕ is, for example, from 10 to 20 mm and the thickness is, for example, about 0.3 mm (millimeters). In addition to being small and thin, the lithium-ion battery can be charged and discharged and is in an all solid state, and therefore can be favorably used as a power supply for a portable information terminal such as a smartphone. The size and the thickness of the lithium-ion battery 300 are not limited to the above values as long as it can be molded. In a case where the size of the outer shape thereof is from 10 to 20 mm ϕ as in this embodiment, the thickness from the positive electrode 310 to the negative electrode composite material 330 is about 0.3 mm from the viewpoint of moldability when it is thin, and is up to about 1 mm estimated from the viewpoint of lithium ion conduction property when it is thick, and if it is too thick, the utilization efficiency of the active material is deteriorated. Note that the shape of the lithium-ion battery 300 is not limited to a circular disk shape, and may be a polygonal disk shape. Hereinafter, the respective configurations will be described in detail.

### 3-1-1. Negative Electrode Composite Material

As shown in FIG. 12, the negative electrode composite material 330 in the lithium-ion battery 300 of this embodiment is configured to include a negative electrode active material 331 in a particulate shape and a solid electrolyte 332. In such a negative electrode composite material 330, the battery reaction rate in the lithium-ion battery 300 can be increased by increasing an interfacial area where the negative electrode active material 331 in a particulate shape and the solid electrolyte 332 are in contact with each other.

As the negative electrode active material 331 to be used for the negative electrode composite material 330, it is preferred to adopt a material in a particulate shape having a particle diameter of 100 nm to 100 μm, and it is more preferred to adopt a material having a particle diameter of 300 nm to 30 μm. Here, the particle diameter represents the maximum diameter of the particle of the negative electrode active material 331. Note that in FIG. 12, the shape of the negative electrode active material 331 in a particulate shape is shown as a spherical shape, however, the shape of the negative electrode active material 331 is not limited to the spherical shape, and it is considered that the material has various shapes such as a columnar shape, a plate shape, and a hollow shape, but actually the material has an indefinite shape. Therefore, the particle diameter of the negative electrode active material 331 in a particulate shape is sometimes represented as an average particle diameter.

As such a negative electrode active material 331, as described in the above first embodiment, Nb₂O₅, V₂₀₅, TiO₂, In₂O₃ (indium oxide), ZnO (zinc oxide), SnO₂ (tin oxide), NiO, ITO (indium oxide doped with Sn), AZO (zinc oxide doped with aluminum), GZO (zinc oxide doped with gallium), ATO (tin oxide doped with antimony), FTO (tin oxide doped with fluoride), and lithium composite oxides such as Li₄Ti₅O₁₂ and Li₂Ti₃O₇ are exemplified. Further, metals and alloys such as Li, Al, Si, Si—Mn, Si—Co, Si—Ni, Sn, Zn, Sb, Bi, In, and Au, carbon materials, and materials obtained by intercalation of lithium ions between layers of a carbon material (such as LiC₂₄ and LiC₆), and the like are exemplified, and among these, one or more types are selected.

Further, the negative electrode composite material 330 is combined with an electrolyte, an electric conduction assistant, a binder, or the like other than the negative electrode active material 331 according to a required property or design. In this embodiment, the solid electrolyte 332 included in the negative electrode composite material 330 is formed using the precursor composition for a solid electrolyte of this embodiment from the viewpoint of an ion conduction property, chemical stability, and an interfacial impedance with the electrolyte layer 320.

That is, the solid electrolyte 332 is represented by the following compositional formula (1).

Li₇₋ₓLa₃(Zr₂₋ₓ,Mₓ)O₁₂ (1)

In the above compositional formula (1), as the element M, one or more types are selected from Nb, Ta, and Sb, and x satisfies 0<x<2.0.

As the electric conduction assistant, any may be used as long as it is an electric conductor whose electrochemical interaction can be ignored at a negative electrode reaction potential. A carbon material such as acetylene black, Ketjen black, or a carbon nanotube, a noble metal such as palladium or platinum, an electrically conductive oxide such as SnO₂, ZnO, RuO₂, ReO₃, or Ir₂O₃ can be used.

### 3-1-2. Electrolyte Layer

The electrolyte layer 320 is preferably constituted by the same material as the solid electrolyte 332 from the viewpoint of an interfacial impedance with the negative electrode composite material 330, but a crystalline material or an amorphous material of another oxide solid electrolyte, a sulfide solid electrolyte, a nitride solid electrolyte, a halide solid electrolyte, a hydride solid electrolyte, a dry polymer electrolyte, or a quasi-solid electrolyte can also be used by being mixed or by itself.

Examples of a crystalline oxide, examples of a crystalline sulfide, and examples of an amorphous material are the same as those described in the above-mentioned first embodiment, and therefore, the detailed description will be omitted here.

In the case of a crystalline material, the crystalline material preferably has a crystal structure such as a cubic crystal having small crystal plane anisotropy in the direction of lithium ion conduction. Further, in the case of an amorphous material, the anisotropy in lithium ion conduction is small, and therefore, such a crystalline material or an amorphous material is each preferred as a solid electrolyte constituting the electrolyte layer 320.

The thickness of the electrolyte layer 320 is preferably 0.1 μm or more and 100 μm or less, and more preferably 0.2 μm or more and 10 μm or less. By setting the thickness of the electrolyte layer 320 within the above range, the internal resistance of the electrolyte layer 320 can be decreased, and also the occurrence of a short circuit between the positive electrode 310 and the negative electrode composite material 330 can be suppressed.

Note that in the face that comes in contact with the negative electrode composite material 330 of the electrolyte layer 320, a three-dimensional pattern structure of a dimple, a trench, a pillar, or the like may be formed by combining various molding methods or processing methods as needed.

### 3-1-3. Positive Electrode

As the positive electrode 310, any may be used as long as it is a positive electrode active material that can repeat electrochemical occlusion and release of lithium ions. Therefore, it can adopt the same configuration as that of the positive electrode 10 in the lithium-ion battery 100 of the first embodiment described above. Therefore, the detailed description will be omitted here.

### 3-1-4. Current Collector

The current collector is an electric conductor provided so as to play a role in transfer of electrons to the positive electrode 310 or the negative electrode composite material 330, and a material that has a sufficiently small electrical resistance and does not change the electric conduction property or the mechanical structure thereof by charging and discharging is selected. Therefore, the current collector 341 in contact with the positive electrode 310 and the current collector 342 in contact with the negative electrode composite material 330 can adopt the same configuration as that of the current collectors 41 and 42 in the lithium-ion battery 100 of the first embodiment described above. Therefore, the detailed description will be omitted here. Note that in the lithium-ion battery 300, the pair of current collectors 341 and 342 is not essential, and a configuration in which only one of them is included may be adopted.

### 3-2. Method for Producing Secondary Battery

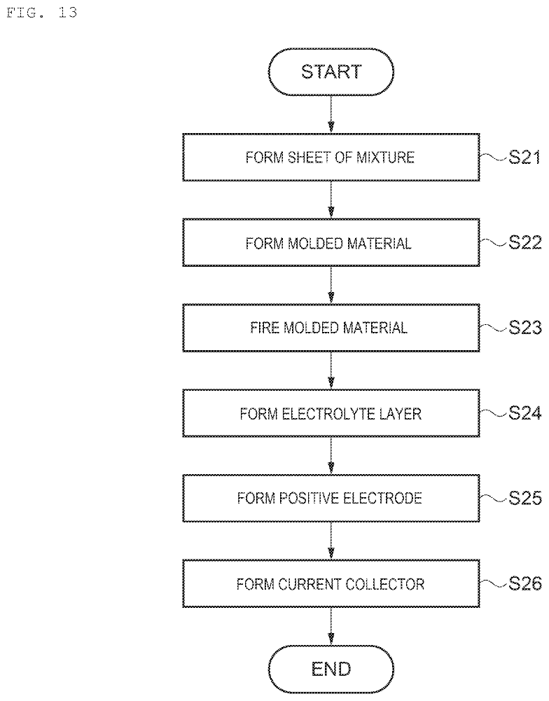

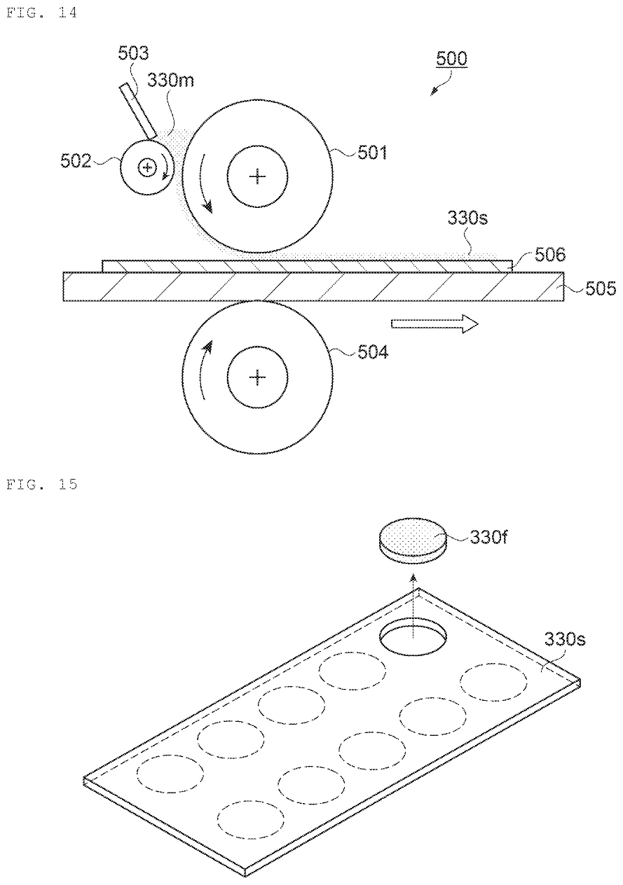

Next, a method for producing the lithium-ion battery as the secondary battery of this embodiment will be described by showing a specific example. FIG. 13 is a flowchart showing a method for producing the lithium-ion battery as the secondary battery of the third embodiment, and FIGS. 14 and 15 are each a schematic view showing the method for producing the lithium-ion battery as the secondary battery of the third embodiment.

As shown in FIG. 13, the method for producing the lithium-ion battery 300 of this embodiment includes a step of forming a sheet of a mixture (Step S21), a step of forming a molded material (Step S22), a step of firing the molded material (Step S23), a step of forming the electrolyte layer 320 (Step S24), a step of forming the positive electrode 310 (Step S25), and a step of forming the current collectors 341 and 342 (Step S26).

In the step of forming a sheet of a mixture of Step S21, 15 g of a Li₄Ti₅O₁₂ powder manufactured by Sigma-Aldrich Co. LLC. having an average particle diameter of 5 μm as the negative electrode active material 331, 18 g of a powder of the precursor composition for a solid electrolyte of this embodiment, and g of polypropylene carbonate (PPC) manufactured by Sigma-Aldrich Co. LLC. as a binder are mixed in 90 g of 1,4-dioxane that is a solvent manufactured by Kanto Chemical Co., Inc. and formed into a slurry by mixing. Then, as shown in FIG. 14, the obtained slurry 330m was fed to a fully automatic film applicator 500 and applied onto a base material 506, whereby a negative electrode composite material mixture sheet 330s having a width of 5 cm, a length of 10 cm, and a thickness of 70 μm was obtained. Then, the process proceeds to Step S22.

In the step of forming a molded material of Step S22, the negative electrode composite material mixture sheet 330s was dried in the air for 8 hours, and the negative electrode composite material mixture sheet 330s was detached from the base material 506, and as shown in FIG. 15, a molded material 330f having a diameter ϕ of 20 mm was obtained by punching. Then, the process proceeds to Step S23.

In the step of firing the molded material of Step S23, the molded material 330f was sintered at 900° C. for 8 hours in an oxidative atmosphere, whereby the negative electrode composite material 330 was obtained. Then, the process proceeds to Step S24.

In the step of forming the electrolyte layer 320 of Step S24, the electrolyte layer 320 was formed at one face 330a (see FIG. 12) of the negative electrode composite material 330. Specifically, by using a sputtering device SSP2000 (manufactured by Suga Works Co., Ltd.), the electrolyte layer 320 was formed by forming a Li_{2.2}C_{0.8}B_{0.2}O₃ layer at the one face 330a (see FIG. 12) of the negative electrode composite material 330 using a solid solution Li_{2.2}C_{0.8}B_{0.2}O₃ (manufactured by Toshima Manufacturing Co., Ltd.) of Li₂CO₃ and Li₃BO₃ having a diameter ϕ of 4.9 cm as a target. A portion of the negative electrode composite material 330 after sputtering was analyzed with a field-emission surface scanning electron microscope XL30FEG manufactured by Royal Philips, it was found that a Li_{2.2}C_{0.8}B_{0.2}O₃ layer having a thickness of 5.6 μm was formed. Then, the process proceeds to Step S25.

In the step of forming the positive electrode 310 of Step S25, the positive electrode 310 was formed at the one face 330a side of the negative electrode composite material 330. Specifically, by using a sputtering device SSP2000 (manufactured by Suga Works Co., Ltd.), a LiCoO₂ layer was formed at one face 320a (see FIG. 12) of the electrolyte layer 320 using LiCoO₂ (manufactured by Toshima Manufacturing Co., Ltd.) having a diameter ϕ of 4.9 cm as a target. Argon gas was used as the carrier gas. After sputtering, the electrolyte layer 320 at which the LiCoO₂ layer was formed and the negative electrode composite material 330 were fired at 500° C. for 2 hours in an oxidative atmosphere to convert the crystal of the LiCoO₂ layer to a high-temperature phase crystal, whereby the positive electrode 310 having a thickness of 5.4 μm was obtained. Then, the process proceeds to Step S26.

In the step of forming the current collectors 341 and 342 of Step S26, the current collector 341 was formed so as to come in contact with the one face 310a (see FIG. 12) of the positive electrode 310, and the current collector 342 was formed so as to come in contact with the other face 330b (see FIG. 12) of the negative electrode composite material 330. Specifically, an aluminum foil having a thickness of 40 μm punched to a diameter ϕ of 15 mm was joined to the positive electrode 310 by pressing, whereby the current collector 341 was formed. Further, a copper foil having a thickness of 20 μm punched to a diameter ϕ of 15 mm was joined to the negative electrode composite material 330 by pressing, whereby the current collector 342 was formed. Note that the step of forming a current collector may be configured to form only one of the pair of current collectors 341 and 342.

Further, the method for forming the negative electrode composite material 330 and the electrolyte layer 320 is not limited to the method shown in Step S21 to Step S24. For example, the following method may be adopted. 15 g of a powder of the precursor composition for a solid electrolyte of this embodiment and 10 g of PPC as a binder are mixed in 40 g of 1,4-dioxane that is a solvent and formed into a slurry by mixing. Then, the obtained slurry is fed to the fully automatic film applicator 500 and applied onto the base material 506, whereby an electrolyte mixture sheet having a width of 5 cm, a length of 10 cm, and a thickness of 20 μm is formed. In Step S22, the negative electrode composite material mixture sheet 330s detached from the base material 506 and the electrolyte mixture sheet are stacked and bonded to each other by roll pressing at 90° C. with a pressure of 4 MPa. The stacked sheet obtained by bonding is punched to form a molded material, and the molded material is sintered at 900° C. for 8 hours in an oxidative atmosphere, whereby a stacked body in which the electrolyte layer 320 and the negative electrode composite material 330 are stacked is obtained.

According to the method for producing the lithium-ion battery 300 as the secondary battery of the third embodiment described above, the following effect is obtained.

The negative electrode composite material 330 is formed by sintering a mixture obtained by mixing the negative electrode active material 331 in a particulate shape and a powder of the precursor composition for a solid electrolyte of this embodiment. Therefore, the negative electrode composite material 330 is configured to include the negative electrode active material 331 in a particulate shape and the solid electrolyte 332 represented by the following compositional formula (1), so that the lithium-ion battery 300, in which lithium ions are smoothly conducted at an interface between the negative electrode active material 331 in a particulate shape and the solid electrolyte 332, and which has excellent charge-discharge characteristics can be produced.

Li₇₋ₓLa₃(Zr₂₋ₓ,Mₓ)O₁₂ (1)

In the above compositional formula (1), as the element M, one or more types are selected from Nb, Ta, and Sb, and x satisfies 0<x<2.0.

### 4. FOURTH EMBODIMENT

### 4-1. Secondary Battery

Next, another example of the secondary battery including the solid electrolyte formed using the precursor composition for a solid electrolyte of this embodiment will be described by showing a lithium-ion battery as an example in the same manner as the above-mentioned first embodiment.

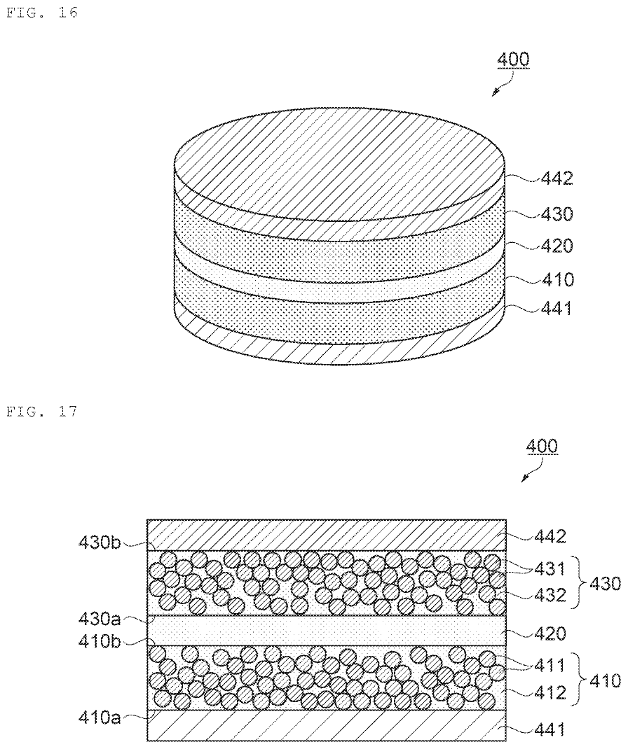

FIG. 16 is a schematic perspective view showing a configuration of a lithium-ion battery as a secondary battery of a fourth embodiment, and FIG. 17 is a schematic cross-sectional view showing a structure of the lithium-ion battery as the secondary battery of the fourth embodiment.

As shown in FIG. 16, a lithium-ion battery 400 as the secondary battery of this embodiment includes a positive electrode composite material 410, and an electrolyte layer 420 and a negative electrode composite material 430, which are sequentially stacked on the positive electrode composite material 410. Further, the lithium-ion battery includes a current collector 441 in contact with the positive electrode composite material 410 and a current collector 442 in contact with the negative electrode composite material 430.

The positive electrode composite material 410, the solid electrolyte layer 420, and the negative electrode composite material 430 are all constituted by a solid phase, and therefore, the lithium-ion battery 400 of this embodiment is also an all-solid-state secondary battery that can be charged and discharged.

The lithium-ion battery 400 of this embodiment has, for example, a circular disk shape, and the size of the outer shape thereof is such that the diameter ϕ is, for example, from 10 to 20 mm and the thickness is, for example, about 0.3 mm (millimeters). In addition to being small and thin, the lithium-ion battery can be charged and discharged and is in an all solid state, and therefore can be favorably used as a power supply for a portable information terminal such as a smartphone. The size and the thickness of the lithium-ion battery 400 are not limited to the above values as long as it can be molded. In a case where the size of the outer shape thereof is from 10 to 20 mm ϕ as in this embodiment, the thickness from the positive electrode composite material 410 to the negative electrode composite material 430 is about 0.3 mm from the viewpoint of moldability when it is thin, and is up to about 1 mm estimated from the viewpoint of lithium ion conduction property when it is thick, and if it is too thick, the utilization efficiency of the active material is deteriorated. Note that the shape of the lithium-ion battery 400 is not limited to a circular disk shape, and may be a polygonal disk shape. Hereinafter, the respective configurations will be described in detail.

### 4-1-1. Positive Electrode Composite Material

As shown in FIG. 17, the positive electrode composite material 410 is configured to include a positive electrode active material 411 in a particulate shape that can repeat electrochemical occlusion and release of lithium ions, and a solid electrolyte 412 formed using the precursor composition for a solid electrolyte of this embodiment. That is, the positive electrode composite material 410 of this embodiment can adopt the same configuration as that of the positive electrode composite material 210 in the lithium-ion battery 200 of the second embodiment described above. That is, the positive electrode active material 411 has the same configuration as that of the positive electrode active material 211 described in the second embodiment, and therefore, the detailed description will be omitted here.

Further, the solid electrolyte 412 is represented by the following compositional formula (1).

Li₇₋ₓLa₃(Zr₂₋ₓ,Mₓ)O₁₂ (1)

In the above compositional formula (1), as the element M, one or more types are selected from Nb, Ta, and Sb, and x satisfies 0<x<2.0.

Further, the positive electrode composite material 410 is combined with an electrolyte, an electric conduction assistant, a binder, or the like other than the positive electrode active material 411 according to a required property or design. As the electric conduction assistant, any may be used as long as it is an electric conductor whose electrochemical interaction can be ignored at a positive electrode reaction potential. A carbon material such as acetylene black, Ketjen black, or a carbon nanotube, a noble metal such as palladium or platinum, an electrically conductive oxide such as SnO₂, ZnO, RuO₂, ReO₃, or Ir₂O₃ can be used.

### 4-1-2. Negative Electrode Composite Material

As shown in FIG. 17, the negative electrode composite material 430 is configured to include a negative electrode active material 431 in a particulate shape that can repeat electrochemical occlusion and release of lithium ions, and a solid electrolyte 432 formed using the precursor composition for a solid electrolyte of this embodiment. That is, the negative electrode composite material 430 of this embodiment can adopt the same configuration as that of the negative electrode composite material 330 in the lithium-ion battery 300 of the third embodiment described above. That is, the negative electrode active material 431 has the same configuration as that of the negative electrode active material 331 described in the third embodiment, and therefore, the detailed description will be omitted here.

Further, the solid electrolyte 432 is represented by the following compositional formula (1).

Li₇₋ₓLa₃(Zr₂₋ₓ,Mₓ)O₁₂ (1)

In the above compositional formula (1), as the element M, one or more types are selected from Nb, Ta, and Sb, and x satisfies 0<x<2.0.

Further, the negative electrode composite material 430 is combined with an electrolyte, an electric conduction assistant, a binder, or the like other than the negative electrode active material 431 according to a required property or design. As the electric conduction assistant, any may be used as long as it is an electric conductor whose electrochemical interaction can be ignored at a negative electrode reaction potential. A carbon material such as acetylene black, Ketjen black, or a carbon nanotube, a noble metal such as palladium or platinum, an electrically conductive oxide such as SnO₂, ZnO, RuO₂, ReO₃, or Ir₂O₃ can be used.

### 4-1-3. Electrolyte Layer

The electrolyte layer 420 is preferably configured to include the same material as the solid electrolyte 412 and the solid electrolyte 432 from the viewpoint of an interfacial impedance with the positive electrode composite material 410 and the negative electrode composite material 430, but a crystalline material or an amorphous material of another oxide solid electrolyte, a sulfide solid electrolyte, a nitride solid electrolyte, a halide solid electrolyte, a hydride solid electrolyte, a dry polymer electrolyte, or a quasi-solid electrolyte can also be used by being mixed or by itself.

Examples of a crystalline oxide, examples of a crystalline sulfide, and examples of an amorphous material are the same as those described in the above-mentioned first embodiment, and therefore, the detailed description will be omitted here.

In the case of a crystalline material, the crystalline material preferably has a crystal structure such as a cubic crystal having small crystal plane anisotropy in the direction of lithium ion conduction. Further, in the case of an amorphous material, the anisotropy in lithium ion conduction is small, and therefore, such a crystalline material or an amorphous material is each preferred as a solid electrolyte constituting the electrolyte layer 420.

The thickness of the electrolyte layer 420 is preferably 0.1 μm or more and 100 μm or less, and more preferably 0.2 μm or more and 10 μm or less. By setting the thickness of the electrolyte layer 420 within the above range, the internal resistance of the electrolyte layer 420 can be decreased, and also the occurrence of a short circuit between the positive electrode composite material 410 and the negative electrode composite material 430 can be suppressed.

Note that in the face that comes in contact with the positive electrode composite material 410 or the negative electrode composite material 430 of the electrolyte layer 420, a three-dimensional pattern structure of a dimple, a trench, a pillar, or the like may be formed by combining various molding methods or processing methods as needed.

### 4-1-4. Current Collector

The current collector is an electric conductor provided so as to play a role in transfer of electrons to the positive electrode composite material 410 or the negative electrode composite material 430, and a material that has a sufficiently small electrical resistance and does not change the electric conduction property or the mechanical structure thereof by charging and discharging is selected. Therefore, the current collector 441 in contact with the positive electrode composite material 410 and the current collector 442 in contact with the negative electrode composite material 430 can adopt the same configuration as that of the current collectors 41 and 42 in the lithium-ion battery 100 of the first embodiment described above. Therefore, the detailed description will be omitted here. Note that in the lithium-ion battery 400, the pair of current collectors 441 and 442 is not essential, and a configuration in which only one of them is included may be adopted.

### 4-2. Method for Producing Secondary Battery

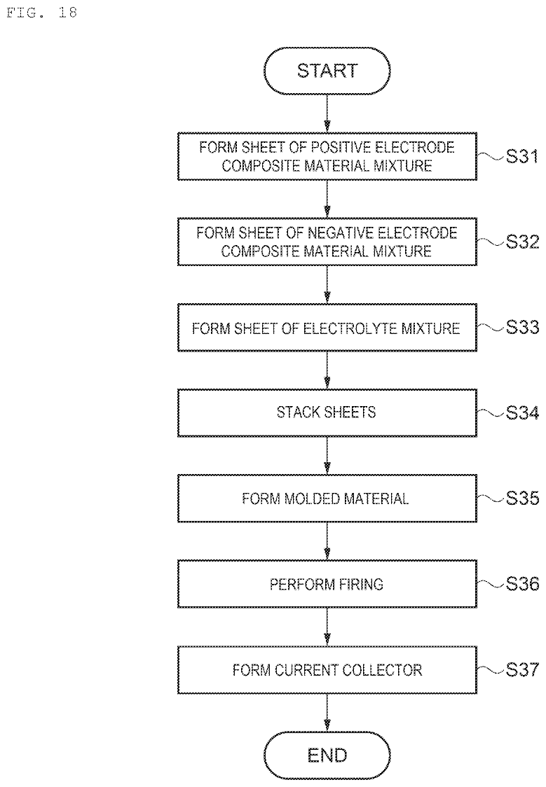

Next, a method for producing the lithium-ion battery as the secondary battery of this embodiment will be described by showing a specific example. FIG. 18 is a flowchart showing a method for producing the lithium-ion battery as the secondary battery of the fourth embodiment, and FIGS. 19 to 22 are each a schematic view showing the method for producing the lithium-ion battery as the secondary battery of the fourth embodiment.

As shown in FIG. 18, the method for producing the lithium-ion battery 400 of this embodiment includes a step of forming a sheet of a positive electrode composite material mixture (Step S31), a step of forming a sheet of a negative electrode composite material mixture (Step S32), a step of forming a sheet of an electrolyte mixture (Step S33), a step of stacking sheets (Step S34), a step of forming a molded material (Step S35), a step of firing the molded material (Step S36), and a step of forming a current collector (Step S37).

In the step of forming a sheet of a positive electrode composite material mixture of Step S31, 15 g of a LiCoO₂ powder manufactured by Nippon Kayaku Co., Ltd. having an average particle diameter of 5 μm as the positive electrode active material 411, 18 g of a powder of the precursor composition for a solid electrolyte of this embodiment, and 10 g of polypropylene carbonate (PPC) manufactured by Sigma-Aldrich Co. LLC. as a binder are mixed in 90 g of 1,4-dioxane that is a solvent manufactured by Kanto Chemical Co., Inc. and formed into a slurry by mixing. Then, as shown in FIG. 19, the obtained slurry 410m was fed to a fully automatic film applicator 500 and applied onto a base material 506, dried in the air for 8 hours, and then, detached from the base material 506, whereby a positive electrode composite material mixture sheet 410s having a width of 5 cm, a length of 10 cm, and a thickness of 70 μm was obtained. Then, the process proceeds to Step S32.

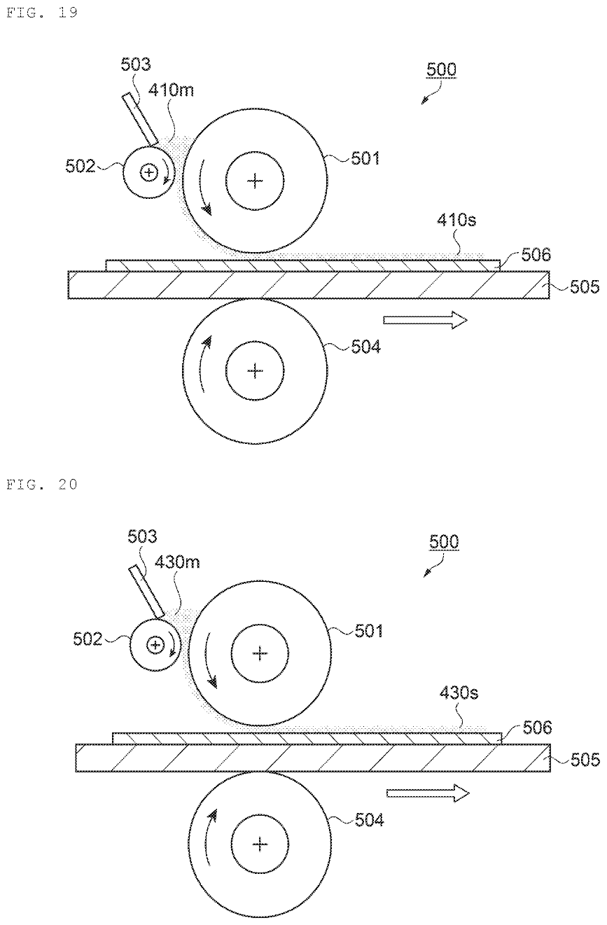

In the step of forming a sheet of a negative electrode composite material mixture of Step S32, 15 g of a Li₄Ti₅O₁₂ powder manufactured by Sigma-Aldrich Co. LLC. having an average particle diameter of 5 μm as the negative electrode active material 431, 18 g of a powder of the precursor composition for a solid electrolyte of this embodiment, and 10 g of polypropylene carbonate (PPC) manufactured by Sigma-Aldrich Co. LLC. as a binder are mixed in 90 g of 1,4-dioxane that is a solvent manufactured by Kanto Chemical Co., Inc. and formed into a slurry by mixing. Then, as shown in FIG. 20, the obtained slurry 430m was fed to the fully automatic film applicator 500 and applied onto the base material 506, dried in the air for 8 hours, and then, detached from the base material 506, whereby a negative electrode composite material mixture sheet 430s having a width of 5 cm, a length of 10 cm, and a thickness of 70 μm was obtained. Then, the process proceeds to Step S33.

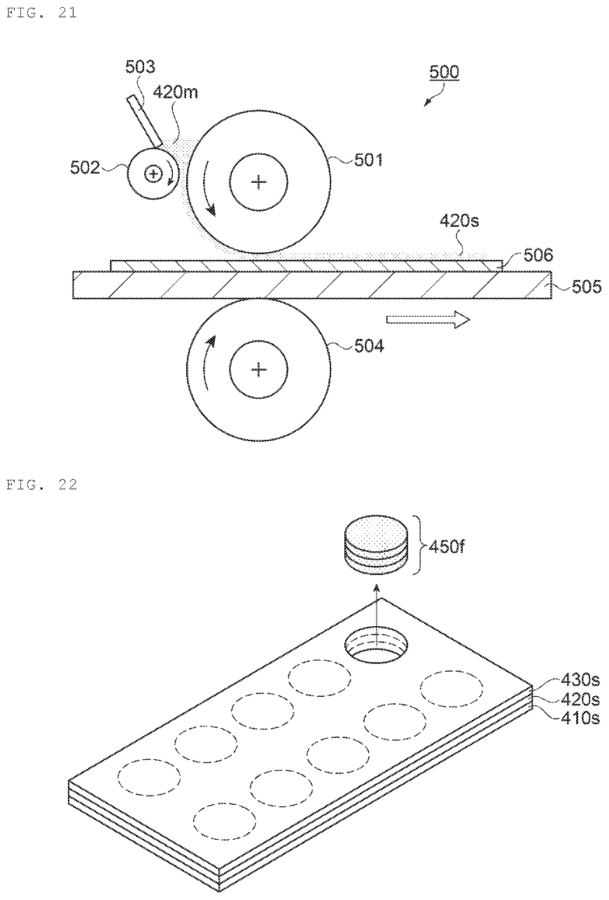

In the step of forming a sheet of an electrolyte mixture of Step S33, 18 g of a powder of the precursor composition for a solid electrolyte of this embodiment and 10 g of polypropylene carbonate (PPC) manufactured by Sigma-Aldrich Co. LLC. as a binder are mixed in 90 g of 1,4-dioxane that is a solvent manufactured by Kanto Chemical Co., Inc. and formed into a slurry by mixing. Then, as shown in FIG. 21, the obtained slurry 420m was fed to the fully automatic film applicator 500 and applied onto the base material 506, dried in the air for 8 hours, and then, detached from the base material 506, whereby an electrolyte mixture sheet 420s having a width of 5 cm, a length of 10 cm, and a thickness of 70 μm was obtained. Then, the process proceeds to Step S34.

In the step of stacking sheets of Step S34, as shown in FIG. 22, the positive electrode composite material mixture sheet 410s, the electrolyte mixture sheet 420s, and the negative electrode composite material mixture sheet 430s are stacked in this order and bonded to one another by roll pressing at 90° C. with a pressure of 4 MPa. The stacked sheet obtained by bonding was punched, whereby a molded material 450f was obtained. Then, the process proceeds to Step S36.

In the firing step of Step S36, the molded material 450f obtained in Step S34 was sintered at 900° C. for 8 hours in an oxidative atmosphere. In the molded material 450f, a portion composed of the positive electrode composite material mixture is converted to the positive electrode composite material 410 by firing, a portion composed of the electrolyte mixture is converted to the electrolyte layer 420 by firing, and a portion composed of the negative electrode composite material mixture is converted to the negative electrode composite material 430. That is, the sintered body of the molded material 450f is a stacked body of the positive electrode composite material 410, the electrolyte layer 420, and the negative electrode composite material 430. Then, the process proceeds to Step S37.

In the step of forming a current collector of Step S36, the current collector 441 was formed so as to come in contact with the one face 410a (see FIG. 17) of the positive electrode composite material 410, and the current collector 442 was formed so as to come in contact with the other face 430b (see FIG. 17) of the negative electrode composite material 430. Specifically, an aluminum foil having a thickness of 40 μm punched to a diameter ϕ of 15 mm was joined to the positive electrode composite material 410 by pressing, whereby the current collector 441 was formed. Further, a copper foil having a thickness of 20 μm punched to a diameter ϕ of 15 mm was joined to the negative electrode composite material 430 by pressing, whereby the current collector 442 was formed. Note that the step of forming a current collector may be configured to form only one of the pair of current collectors 441 and 442.

Note that the step of forming a sheet of an electrolyte mixture is not limited to the method shown in Step S33. For example, the following method may be adopted. 15 g of a powder having an average particle diameter of 5 μm obtained by grinding the solid electrolyte of this embodiment as a solid electrolyte, g of a powder of a precursor composition of a solid electrolyte having the same compositional formula of this embodiment, and 10 g of polypropylene carbonate (PPC) manufactured by Sigma-Aldrich Co. LLC. as a binder are mixed in 90 g of 1,4-dioxane that is a solvent manufactured by Kanto Chemical Co., Inc. and formed into a slurry by mixing. Then, as shown in FIG. 21, the obtained slurry 420m is fed to the fully automatic film applicator 500 and applied onto the base material 506, whereby an electrolyte mixture sheet 420s having a width of 5 cm, a length of 10 cm, and a thickness of 70 μm is obtained.

According to the method for producing the lithium-ion battery 400 as the secondary battery of the fourth embodiment described above, the following effect is obtained.

The positive electrode composite material 410 is formed by sintering a mixture obtained by mixing the positive electrode active material 411 in a particulate shape and a powder of the precursor composition for a solid electrolyte of this embodiment. Therefore, the positive electrode composite material 410 is configured to include the positive electrode active material 411 in a particulate shape and the solid electrolyte 412 represented by the following compositional formula (1), so that lithium ions are smoothly conducted at an interface between the positive electrode active material 411 in a particulate shape and the solid electrolyte 412. Similarly, also in the negative electrode composite material 430, by combining the negative electrode active material 431 in a particulate shape with the solid electrolyte 432, lithium ions can be smoothly conducted at an interface. Therefore, in either of the positive electrode composite material 410 and the negative electrode composite material 430, a high battery reaction rate can be achieved, and therefore, the lithium-ion battery 400 having excellent charge-discharge characteristics can be produced.

Li₇₋ₓLa₃(Zr₂₋ₓ,Mₓ)O₁₂ (1)

In the above compositional formula (1), as the element M, one or more types are selected from Nb, Ta, and Sb, and x satisfies 0<x<2.0.

Further, the electrolyte layer 420 is preferably formed by sintering a mixture obtained by mixing the solid electrolyte crystal in a particulate shape and a powder of the precursor composition for a solid electrolyte of this embodiment. According to this, sintering between particles of the solid electrolyte crystal in a particulate shape occurs at a temperature at which the precursor composition for a solid electrolyte of this embodiment is converted to a crystal, so that the electrolyte layer 420 that is dense and has a high lithium ion conduction property can be formed even by low-temperature sintering.

### 5. EXAMPLES AND COMPARATIVE EXAMPLES

Next, Examples of the solid electrolyte formed using the precursor composition for a solid electrolyte of this embodiment and Comparative Examples will be shown and evaluation results of Examples and Comparative Examples will be specifically described.

### 5-1. EXAMPLES

The solid electrolyte formed using the precursor composition for a solid electrolyte of this embodiment will be described by showing Examples 1 to 9 in which the formulation of the element M or the like is made different.

Specific configurations of respective raw material compounds to be used in the formation of the solid electrolytes of Examples 1 to 9 are as follows.

The lithium compound is lithium nitrate (LiNO₃) manufactured by Kanto Chemical Co., Inc., the lanthanum compound is lanthanum nitrate hexahydrate (La(NO₃)₃.6H₂O) manufactured by Kanto Chemical Co., Inc., and the zirconium compound is zirconium butoxide manufactured by Sigma-Aldrich Co. LLC. The niobium compound is niobium pentaethoxide manufactured by Kojundo Chemical Laboratory Co., Ltd., the tantalum compound is tantalum ethoxide manufactured by Gelest, Inc., and the antimony compound is antimony tri-n-butoxide manufactured by Kojundo Chemical Laboratory Co., Ltd., each of which is used as the element M.

### 5-1-1. Example 1

The solid electrolyte of Example 1 is represented by the compositional formula: Li_{6.3}La₃Zr_{1.3}Sb_{0.5}Ta_{0.2}O₁₂. Lithium nitrate, lanthanum nitrate, zirconium butoxide, antimony tri-n-butoxide, and tantalum ethoxide are weighed, respectively, according to the molar ratio in the compositional formula of Example 1 and dissolved in 2-n-butoxyethanol that is a solvent. A mixed solution in which the respective raw material compounds were dissolved was placed in a beaker made of titanium and gelled by heating at 140° C., and further heated at 540° C. in an air atmosphere for 30 minutes, whereby a thermal decomposition product in an ash form, that is, a precursor composition for a solid electrolyte of Example 1 was obtained. 1 g of this thermal decomposition product was filled in a pellet die with an exhaust port having an inner diameter ϕ of 13 mm manufactured by Specac, Inc., followed by press molding under a load of 6 kN, whereby a pellet as a molded material was obtained. The obtained pellet was placed in a crucible made of alumina and sintered at 900° C. in an air atmosphere for 8 hours, whereby the solid electrolyte pellet of Example 1 was obtained.

### 5-1-2. Example 2

The solid electrolyte of Example 2 is represented by the compositional formula: Li_{6.7}La₃Zr_{1.7}Nb_{0.25}Ta_{0.05}O₁₂. Lithium nitrate, lanthanum nitrate, zirconium butoxide, niobium pentaethoxide, and tantalum ethoxide are weighed, respectively, according to the molar ratio in the compositional formula of Example 2 and dissolved in 2-n-butoxyethanol that is a solvent. Thereafter, a treatment was performed in the same manner as in Example 1, whereby the solid electrolyte pellet of Example 2 was obtained.

### 5-1-3. Example 3

The solid electrolyte of Example 3 is represented by the compositional formula: Li_{6.35}La₃Zr_{1.35}Nb_{0.25}Sb_{0.4}O₁₂. Lithium nitrate, lanthanum nitrate, zirconium butoxide, niobium pentaethoxide, and antimony tri-n-butoxide are weighed, respectively, according to the molar ratio in the compositional formula of Example 3 and dissolved in 2-n-butoxyethanol that is a solvent. Thereafter, a treatment was performed in the same manner as in Example 1, whereby the solid electrolyte pellet of Example 3 was obtained.

### 5-1-4. Example 4

The solid electrolyte of Example 4 is represented by the compositional formula: Li_{5.95}La₃Zr_{0.95}Nb_{0.25}Sb_{0.4}Ta_{0.4}O₁₂. Lithium nitrate, lanthanum nitrate, zirconium butoxide, niobium pentaethoxide, antimony tri-n-butoxide, and tantalum ethoxide are weighed, respectively, according to the molar ratio in the compositional formula of Example 4 and dissolved in 2-n-butoxyethanol that is a solvent. Thereafter, a treatment was performed in the same manner as in Example 1, whereby the solid electrolyte pellet of Example 4 was obtained.

### 5-1-5. Example 5

The solid electrolyte of Example 5 is represented by the compositional formula: Li_{6.75}La₃Zr_{1.75}Nb_{0.25}O₁₂. Lithium nitrate, lanthanum nitrate, zirconium butoxide, and niobium pentaethoxide are weighed, respectively, according to the molar ratio in the compositional formula of Example 5 and dissolved in 2-n-butoxyethanol that is a solvent. Thereafter, a treatment was performed in the same manner as in Example 1, whereby the solid electrolyte pellet of Example 5 was obtained.

### 5-1-6. Example 6

The solid electrolyte of Example 6 is represented by the compositional formula: Li_{6.75}La₃Zr_{1.75}Sb_{0.25012}. Lithium nitrate, lanthanum nitrate, zirconium butoxide, and antimony tri-n-butoxide are weighed, respectively, according to the molar ratio in the compositional formula of Example 6 and dissolved in 2-n-butoxyethanol that is a solvent. Thereafter, a treatment was performed in the same manner as in Example 1, whereby the solid electrolyte pellet of Example 6 was obtained.

### 5-1-7. Example 7

The solid electrolyte of Example 7 is represented by the compositional formula: Li_{6.75}La₃Zr_{1.75}Ta_{0.25}O₁₂. Lithium nitrate, lanthanum nitrate, zirconium butoxide, and tantalum ethoxide are weighed, respectively, according to the molar ratio in the compositional formula of Example 7 and dissolved in 2-n-butoxyethanol that is a solvent. Thereafter, a treatment was performed in the same manner as in Example 1, whereby the solid electrolyte pellet of Example 7 was obtained.

### 5-1-8. Example 8

The solid electrolyte of Example 8 is an electrolyte represented by the compositional formula: Li_{6.3}La₃Zr_{1.3}Sb_{0.5}Ta_{0.2}O₁₂, and the compositional formula is the same as that of Example 1. Specifically, the solid electrolyte pellet obtained in the same manner as in Example 1 is ground to a solid electrolyte powder using an agate mortar. In 800 mg of the solid electrolyte powder, 400 mg of a precursor composition for a solid electrolyte that is a thermal decomposition product obtained in the same manner as in Example 1 was mixed, followed by press molding and then sintering in the same manner as in Example 1, whereby the solid electrolyte pellet of Example 8 was obtained.

### 5-1-9. Example 9

The solid electrolyte of Example 9 is a mixture of the solid electrolyte of Example 1 represented by the compositional formula: Li_{6.3}La₃Zr_{1.3}Sb_{0.5}Ta_{0.2}O₁₂ and the solid electrolyte of Example 5 represented by the compositional formula: Li_{6.75}La₃Zr_{1.75}Nb_{0.25}O₁₂. Specifically, a solid electrolyte pellet obtained in the same manner as in Example 5 is ground to a solid electrolyte powder using an agate mortar. In 800 mg of the solid electrolyte powder, 400 mg of a precursor composition for a solid electrolyte that is a thermal decomposition product obtained in the same manner as in Example 1 was mixed, followed by press molding and then sintering in the same manner as in Example 1, whereby the solid electrolyte pellet of Example 9 was obtained.

### 5-2. COMPARATIVE EXAMPLES

As for Comparative Examples, a garnet-type solid electrolyte formed using an MOD method was used as Comparative Example 1, a garnet-type solid electrolyte formed using a solid-phase method with respect to Comparative Example 1 was used as Comparative Example 2, and a garnet-type solid electrolyte formed using a solid-phase method while the configuration of the element M was made different with respect to Comparative Example 2 was used as Comparative Example 3. Hereinafter, the configurations of the solid electrolytes and the formation of solid electrolyte pellets of Comparative Examples 1 to 3 will be described.

### 5-2-1. Comparative Example 1

The solid electrolyte of Comparative Example 1 is represented by the compositional formula: Li_{6.75}La₃Zr_{1.75}Nb_{0.25}O₁₂, and the compositional formula is the same as that of Example 5. 1.43 g of (2,4-pentanedionato) lithium as a lithium source, 2.62 g of tris(2,4-pentanedionato) lanthanum hydrate as a lanthanum source, 1.34 g of zirconium butoxide as a zirconium source, and 0.16 g of niobium pentaethoxide as a niobium source were weighed, respectively, and dissolved in 20 g of propionic acid manufactured by Tokyo Chemical Industry Co., Ltd. The resulting solution was placed in a beaker made of titanium and gelled by heating at 140° C., and further heated at 540° C. in an air atmosphere for 30 minutes, whereby a thermal decomposition product in an ash form was obtained. 1 g of this thermal decomposition product was filled in a pellet die with an exhaust port having an inner diameter ϕ of 13 mm manufactured by Specac, Inc., followed by press molding under a load of 6 kN, whereby a pellet as a molded material was obtained. The obtained pellet was placed in a crucible made of alumina and sintered at 900° C. in an air atmosphere for 8 hours, whereby the solid electrolyte pellet of Comparative Example 1 was obtained.

### 5-2-2. Comparative Example 2

The solid electrolyte of Comparative Example 2 is represented by the compositional formula: Li_{6.75}La₃Zr_{1.75}Nb_{0.25}O₁₂, and the compositional formula is the same as that of Comparative Example 1. 2.5 g of a Li₂CO₃ powder as a lithium source, 4.89 g of a La₂O₃ powder as a lanthanum source, 2.16 g of a ZrO₂ powder as a zirconium source, and 0.33 g of a Nb₂O₃ powder as a niobium source were weighed, respectively, and 40 g of n-hexane manufactured by Kanto Chemical Co., Inc. was added thereto and mixed using an agate mortar, whereby a mixture was obtained. 1 g of this mixture was filled in a pellet die with an exhaust port having an inner diameter ϕ of 13 mm manufactured by Specac, Inc., followed by press molding under a load of 6 kN, whereby a pellet as a molded material was obtained. The obtained pellet was placed in a crucible made of alumina and sintered at 900° C. in an air atmosphere for 8 hours, whereby the solid electrolyte pellet of Comparative Example 2 was obtained.

### 5-2-3. Comparative Example 3

The solid electrolyte of Comparative Example 3 is represented by the compositional formula: Li_{5.95}La₃Zr_{0.95}Nb_{0.25}Sb_{0.4}Ta_{0.4}O₁₂, and the compositional formula is the same as that of Example 4. 2.2 g of a Li₂CO₃ powder as a lithium source, 4.89 g of a La₂O₃ powder as a lanthanum source, 1.17 g of a ZrO₂ powder as a zirconium source, 0.33 g of a Nb₂O₃ powder as a niobium source, 0.58 g of a Sb₂O₃ powder as an antimony source, and 0.88 g of a Ta₂O₅ powder as a tantalum source were weighed, respectively, and 40 g of n-hexane manufactured by Kanto Chemical Co., Inc. was added thereto and mixed using an agate mortar, whereby a mixture was obtained. 1 g of this mixture was filled in a pellet die with an exhaust port having an inner diameter ϕ of 13 mm manufactured by Specac, Inc., followed by press molding under a load of 6 kN, whereby a pellet as a molded material was obtained. The obtained pellet was placed in a crucible made of alumina and sintered at 900° C. in an air atmosphere for 8 hours, whereby the solid electrolyte pellet of Comparative Example 3 was obtained.

### 5-3. EVALUATION RESULTS OF EXAMPLES AND COMPARATIVE EXAMPLES

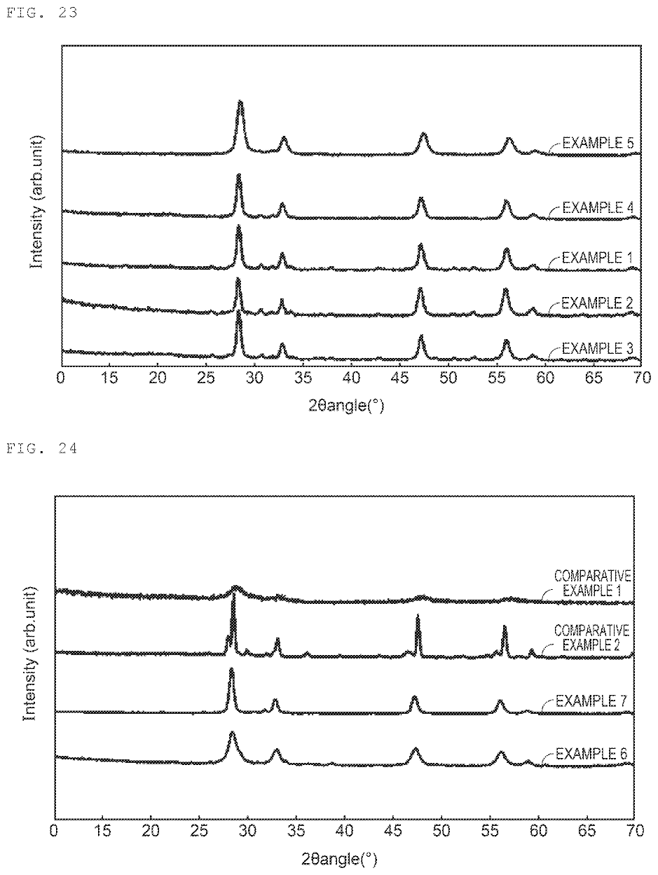

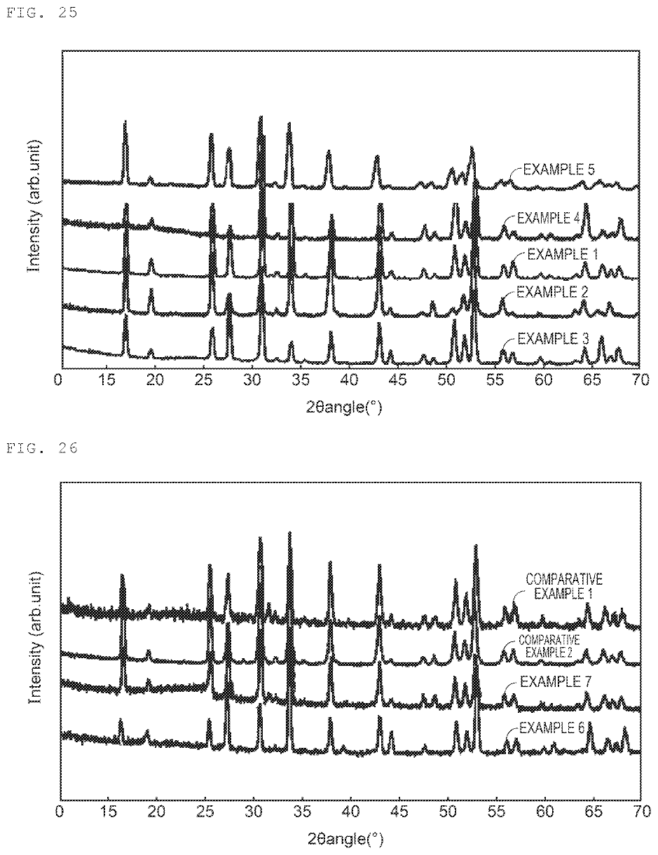

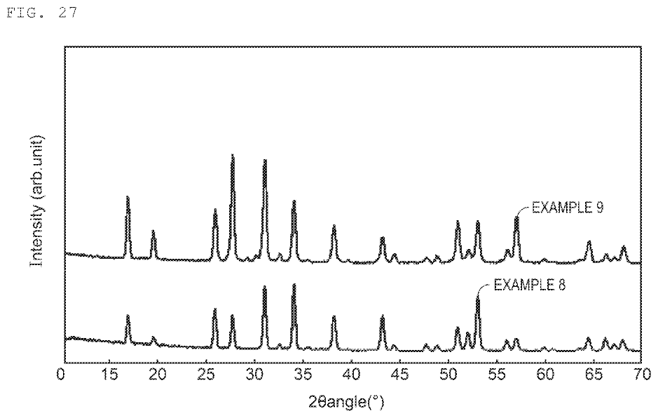

Each of the precursor compositions for solid electrolytes, which are thermal decomposition products, and the solid electrolytes of Examples 1 to 7, the solid electrolytes of Examples 8 and 9, the thermal decomposition product and the solid electrolyte of Comparative Example 1, and the mixtures and the solid electrolytes of Comparative Examples 2 and 3 was used as a sample and analyzed with an X-ray diffractometer X′Pert-PRO manufactured by Royal Philips, whereby X-ray diffraction patterns were obtained. FIG. 23 is a graph showing the X-ray diffraction patterns of the precursor compositions for solid electrolytes of Examples 1 to 5, FIG. 24 is a graph showing the X-ray diffraction patterns of the precursor compositions for solid electrolytes of Examples 6 and 7, the thermal decomposition product of Comparative Example 1, and the mixture of Comparative Example 2. FIG. 25 is a graph showing the X-ray diffraction patterns of the solid electrolytes of Examples 1 to 5, FIG. 26 is a graph showing the X-ray diffraction patterns of the solid electrolytes of Examples 6 and 7 and Comparative Examples 1 and 2, and FIG. 27 is a graph showing the X-ray diffraction patterns of the solid electrolytes of Examples 8 and 9.

As shown in FIGS. 23 and 24, the precursor compositions for solid electrolytes of Examples 1 to 7 show X-ray diffraction intensity peaks at diffraction angles 2θ of 28.4°, 32.88°, 47.2°, 56.01°, and 58.73° in the X-ray diffraction patterns. On the other hand, the thermal decomposition product of Comparative Example 1 obtained using the MOD method shows an X-ray diffraction intensity peak at a diffraction angle 2θ of 28.76° within a range from 0° to 65°, but has no clear peak other than this. The mixture of Comparative Example 2 obtained using the solid-phase method shows X-ray diffraction intensity peaks at diffraction angles 2θ of 28.57°, 33.1°, 39.51°, 47.57°, 56.43°, and 59.19°. That is, it is considered that in the precursor compositions for solid electrolytes of Examples 1 to 7, the thermal decomposition product of Comparative Example 1, and the mixture of Comparative Example 2, the materials contained therein have mutually different crystal structures. Note that the X-ray diffraction pattern of the mixture of Comparative Example 3 is substantially the same as that of Comparative Example 2, and therefore is not shown in FIG. 24.

As shown in FIGS. 25, 26, and 27, in the X-ray diffraction patterns of the solid electrolytes of Examples 1 to 9 and Comparative Examples 1 to 3, a plurality of peaks appearing at diffraction angles 2θ within a range from 0° to 65° were all assigned to a garnet-type or garnet-like crystal in the ICDD database. That is, the solid electrolytes of Examples 1 to 9 and Comparative Examples 1 to 3 obtained after sintering at 900° C. for 8 hours are all considered to have a garnet-type or garnet-like crystal structure.

To the both faces of each of the solid electrolyte pellets of Examples 1 to 9 and Comparative Examples 1 to 3, a lithium metal foil having a diameter of 8 mm (manufactured by Honjo Chemical Corporation) was bonded, whereby activated electrodes were formed. Then, an AC impedance (EIS) was measured using an AC impedance analyzer Solartron 1260 (manufactured by Solartron Analytical, Inc.), and the lithium ion conductivity was determined. The EIS measurement was performed at an AC amplitude of 10 mV in a frequency range from 10⁷ Hz to 10⁻¹ Hz. The lithium ion conductivity obtained by the EIS measurement shows the total lithium ion conductivity including the bulk lithium ion conductivity and the grain boundary lithium ion conductivity in each solid electrolyte pellet. The lithium ion conductivity of each of the solid electrolyte pellets of Examples 1 to 9 and Comparative Examples 1 to 3 is shown in Table 1.

TABLE 1

| | Compositional formula of | Lithium ion |
|---|---|---|
| | solid electrolyte | conductivity (S/cm) |
| Example 1 | Li_{6.3}La₃Zr_{1.3}Sb_{0.5}Ta_{0.2}O₁₂ | 2.8 × 10⁻⁴ |
| Example 2 | Li_{6.7}La₃Zr_{1.7}Nb_{0.25}Ta_{0.05}O₁₂ | 2.1 × 10⁻⁴ |
| Example 3 | Li_{6.35}La₃Zr_{1.35}Nb_{0.25}Sb_{0.4}O₁₂ | 2.9 × 10⁻⁴ |
| Example 4 | Li_{5.95}La₃Zr_{0.95}Nb_{0.25}Sb_{0.4}Ta_{0.4}O₁₂ | 4.8 × 10⁻⁴ |
| Example 5 | Li_{6.75}La₃Zr_{1.75}Nb_{0.25}O₁₂ | 8.4 × 10⁻⁵ |
| Example 6 | Li_{6.75}La₃Zr_{1.75}Sb_{0.25}O₁₂ | 1.3 × 10⁻⁴ |
| Example 7 | Li_{6.75}La₃Zr_{1.75}Ta_{0.25}O₁₂ | 5.5 × 10⁻⁵ |
| Example 8 | Li_{6.3}La₃Zr_{1.3}Sb_{0.5}Ta_{0.2}O₁₂ | 6.9 × 10⁻⁴ |
| Example 9 | Mixture of Example 1 and Example 5 | 4.9 × 10⁻⁴ |
| Comparative | Li_{6.75}La₃Zr_{1.75}Nb_{0.25}O₁₂ (MOD method) | 3.4 × 10⁻⁶ |
| Example 1 | | |
| Comparative | Li_{6.75}La₃Zr_{1.75}Nb_{0.25}O₁₂ (solid-phase method) | 2.2 × 10⁻⁵ |
| Example 2 | | |
| Comparative | Li_{5.95}La₃Zr_{0.95}Nb_{0.25}Sb_{0.4}Ta_{0.4}O₁₂ (solid-phase method) | 7.8 × 10⁻⁵ |
| Example 3 | | |

As shown in the above Table 1, the solid electrolyte pellets of Examples 1 to 9 exhibit a higher lithium ion conductivity than the solid electrolyte pellets of Comparative Examples 1 to 3. Specifically, in Examples 5 to 7 in which as the element M, one type was selected from Nb, Sb, and Ta, the lithium ion conductivity of the solid electrolyte pellet of Example 6 in which Sb was selected is the highest, and the value thereof is 1.3×10⁻⁴ S (siemens)/cm. In comparison to this, the lithium ion conductivities of the solid electrolyte pellets of Examples 1 to 4 in which as the element M, two or more types were selected from Nb, Sb, and Ta all exhibit a value of 2.0×10⁻⁴ S/cm or more, and Example 4 in which three types of Nb, Sb, and Ta were selected exhibits the highest lithium ion conductivity. Further, Example 8 or Example 9 in which the solid electrolyte pellet was obtained by performing sintering again for the molded material obtained by mixing the solid electrolyte powder and the precursor composition for a solid electrolyte achieves a higher lithium ion conductivity than Example 4 in which three types were selected from Nb, Sb, and Ta as the element M. On the other hand, the lithium ion conductivity of the solid electrolyte pellet of Comparative Example 1, in which as the element M, Nb was selected, and which was formed by the MOD method or Comparative Example 2, in which as the element M, Nb was selected, and which was formed by the solid-phase method is lower than that of Example 5 having the same compositional formula and formed by the liquid-phase method. The lithium ion conductivity of the solid electrolyte pellet of Comparative Example 3, in which as the element M, three types were selected from Nb, Sb, and Ta, and which was formed by the solid-phase method, is lower than that of Example 4 having the same compositional formula and formed by the liquid-phase method.

Example 5 and Comparative Example 1 are solid electrolytes represented by the same compositional formula and are also the same in that they are formed by the liquid-phase method, but are different in that the lithium source and the lanthanum source are each a nitrate in Example 5 and are each a metal complex of an organic compound in Comparative Example 1. A high lithium ion conductivity can be achieved when a nitrate is used as the lithium source and the lanthanum source.

A solution in which 0.1 g of the precursor composition for a solid electrolyte represented by the compositional formula: Li_{6.3}La₃Zr_{1.3}Sb_{0.5}Ta_{0.2}O₁₂ of Example 1 was dissolved in a mixed acid of nitric acid, hydrofluoric acid, sulfuric acid, or the like was prepared. The elements contained in the solution were quantitatively determined using an ICP-AES measurement device Agilent 5110 manufactured by Agilent Technologies Japan, Ltd.

Further, 0.25 g of the precursor composition for a solid electrolyte of Example 1 was suspended in 10 mL (milliliters) of ultrapure water and shaken at 23° C. for 1 hour to extract the suspension. The suspension was centrifuged at about 10,000 G for 10 minutes, and the supernatant was further filtered through a syringe filter having a pore diameter of 0.22 μm to obtain a filtrate as an extract. Nitrate ions contained in this extract were quantitatively determined using an ion chromatograph ICS-1000 manufactured by Nippon Dionex K.K. The results of quantitative determination by ICP-AES and the results of quantitative determination by the ion chromatograph are shown in Table 2. Note that Table 2 shows the mass % of Li, La, Zr, Sb, Ta, and nitrate ions contained in each sample and the average mass % thereof as the results of analyzing 5 samples.

TABLE 2

| | | Mass (%) | | | | | |
|---|---|---|---|---|---|---|---|
| Element | Molar mass | Sample 1 | Sample 2 | Sample 3 | Sample 4 | Sample 5 | Average |
| Li | 6.94 | 4.5 | 4.6 | 4.8 | 4.7 | 4.9 | 4.7 |
| La | 138.91 | 36 | 37 | 37 | 38 | 38 | 37.2 |
| Zr | 91.224 | 11 | 11 | 11 | 11 | 11 | 11 |
| Sb | 121.76 | 5.3 | 5.4 | 5.5 | 5.6 | 5.6 | 5.48 |
| Ta | 180.95 | 3.5 | 3.5 | 3.6 | 3.7 | 3.7 | 3.6 |
| NO₃_{^{−}} | 62.05 | 4.8 | 4.7 | 0.7 | 1.1 | 1.8 | 2.62 |

Since a nitrate is used as each of the lithium source and the lanthanum source, as shown in the above Table 2, it is apparent that the precursor composition for a solid electrolyte of Example 1 contains approximately about a little less than 3 mass % of nitrate ions. Since a nitrate is used as each of the lithium source and the lanthanum source also in the other Examples 2 to 7, it is considered that nitrate ions are detected similarly when a sample is prepared and subjected to ion chromatography.

Note that the invention is not limited to the above-mentioned embodiments, and various changes, improvements, etc. can be added to the above-mentioned embodiments. Hereinafter, modifications will be described.

### (First Modification)

The secondary battery including the solid electrolyte formed using the precursor composition for a solid electrolyte of this embodiment is not limited to the all-solid-state lithium-ion battery shown in the above respective embodiments. For example, the secondary battery may have a configuration in which a porous separator is provided between the positive electrode composite material 210 and the negative electrode 230, and the separator is impregnated with an electrolyte solution.

### (Second Modification)

Examples of an electronic apparatus to which the lithium-ion battery shown in each of the above-mentioned embodiments is applied as a power supply include portable-type electronic apparatuses and wearable-type electronic apparatuses to be used by being worn on a part of the body such as a head-mounted display, a head-up display, a portable telephone, a portable information terminal, a notebook personal computer, a digital camera, a video camera, a music player, a wireless headphone, and a gaming machine. Further, the lithium-ion battery can be applied not only to apparatuses for general consumers, but also to apparatuses for industrial use, and the apparatus may be a moving object such as an automobile or a ship. For example, the lithium-ion battery as the secondary battery using the solid electrolyte of this embodiment can be favorably adopted as a storage battery for an electric vehicle (EV), a plugin hybrid electric vehicle (PHEV), a hybrid electric vehicle (HEV), a fuel cell vehicle (FCV), or the like. Hereinafter, contents derived from the embodiments will be described.

The precursor composition fora solid electrolyte of this application is a precursor composition for a garnet-type or garnet-like solid electrolyte containing Li, La, Zr, and M, and is characterized in that the M is one or more types of elements selected from Nb, Ta, and Sb, the compositional ratio of Li:La:Zr:M in the solid electrolyte is 7-x:3:2-x:x, and a relationship of 0<x<2.0 is satisfied, and the precursor composition exhibits X-ray diffraction intensity peaks at diffraction angles 2θ of 28.4°, 32.88°, 47.2°, 56.01°, and 58.73° in an X-ray diffraction pattern.

According to the configuration of this application, a precursor composition for a solid electrolyte capable of achieving a high lithium ion conductivity even if it is sintered at a temperature of 1000° C. or lower can be provided.

It is preferred that the precursor composition for a solid electrolyte described above contains nitrate ions.

According to the configuration, the temperature of the heat treatment involved in sintering can be lowered as compared to a case where nitrate ions are not contained. In other words, by containing nitrate ions, the melting point of the precursor composition for a solid electrolyte is lowered, and even if it is sintered at a temperature of 1000° C. or lower, sintering proceeds, and a high lithium ion conductivity can be achieved.

It is preferred that in the precursor composition for a solid electrolyte described above, the M is two or more types of elements selected from Nb, Ta, and Sb.

According to the configuration, by selecting two or more types from Nb, Ta, and Sb as the element M that partially substitutes the Zr sites, a higher lithium ion conductivity can be achieved.

A method for producing a secondary battery of this application is characterized by including a step of forming a solid electrolyte layer by forming a molded material using the precursor composition for a solid electrolyte described above, and sintering the molded material, a step of forming a positive electrode at one face of the solid electrolyte layer, a step of forming a negative electrode at the other face of the solid electrolyte layer, and a step of forming a current collector in contact with at least one of the positive electrode and the negative electrode.

According to the method of this application, a solid electrolyte layer is formed using the precursor composition for a solid electrolyte described above, and therefore, a solid electrolyte layer having a high lithium ion conductivity is obtained, and a secondary battery having excellent charge-discharge characteristics can be produced.

Further, another method for producing a secondary battery of this application is characterized by including a step of forming a positive electrode composite material by forming a molded material including the precursor composition for a solid electrolyte described above and a positive electrode active material, and sintering the molded material, a step of forming a negative electrode at one face of the positive electrode composite material, and a step of forming a current collector at the other face of the positive electrode composite material.

According to the method of this application, the positive electrode composite material is formed using the precursor composition for a solid electrolyte described above, and therefore, a secondary battery, in which lithium ions are smoothly conducted between the positive electrode active material and the solid electrolyte in the positive electrode composite material, and which has excellent charge-discharge characteristics can be produced.

Further, another method for producing a secondary battery of this application is characterized by including a step of forming a negative electrode composite material by forming a molded material including the precursor composition for a solid electrolyte described above and a negative electrode active material, and sintering the molded material, a step of forming a positive electrode at one face of the negative electrode composite material, and a step of forming a current collector at the other face of the negative electrode composite material.

According to the method of this application, the negative electrode composite material is formed using the precursor composition for a solid electrolyte described above, and therefore, a secondary battery, in which lithium ions are smoothly conducted between the negative electrode active material and the solid electrolyte in the negative electrode composite material, and which has excellent charge-discharge characteristics can be produced.

Another method for producing a secondary battery of this application is characterized by including a step of forming a sheet of a positive electrode composite material mixture including the precursor composition for a solid electrolyte described above and a positive electrode active material, a step of forming a sheet of a negative electrode composite material mixture including the precursor composition for a solid electrolyte described above and a negative electrode active material, a step of forming a sheet of an electrolyte mixture including a solid electrolyte, a step of forming a stacked body by stacking the sheet of the positive electrode composite material mixture, the sheet of the electrolyte mixture, and the sheet of the negative electrode composite material mixture in this order, a step of forming a molded material by molding the stacked body, a step of firing the molded material, and a step of forming a current collector at at least one face of the fired molded material.

According to the method of this application, the sheet of the positive electrode composite material mixture and the sheet of the negative electrode composite material mixture are formed using the precursor composition for a solid electrolyte described above, and therefore, in the fired molded material, the positive electrode composite material including the solid electrolyte and the positive electrode active material, and the negative electrode composite material including the solid electrolyte and the negative electrode active material are contained. Between the positive electrode composite material and the negative electrode composite material, an electrolyte layer is formed from the fired electrolyte mixture. Therefore, a secondary battery, in which lithium ions are smoothly conducted between the positive electrode active material and the solid electrolyte in the positive electrode composite material, and also lithium ions are smoothly conducted between the negative electrode active material and the solid electrolyte in the negative electrode composite material, and which has excellent charge-discharge characteristics can be produced.

It is preferred that in the another method for producing a secondary battery described above, the solid electrolyte is formed using the precursor composition for a solid electrolyte described above.

According to the method, a solid electrolyte having a high lithium ion conductivity is contained in the sheet of the electrolyte mixture, and therefore, in the fired molded material, an electrolyte layer in which lithium ions are smoothly conducted between the positive electrode composite material and the negative electrode composite material is formed, and a secondary battery having more excellent charge-discharge characteristics can be produced.

1. A precursor composition for a solid electrolyte, which is a precursor composition for a garnet-type or garnet-like solid electrolyte containing Li, La, Zr, and M, wherein
the M is one or more types of elements selected from Nb, Ta, and Sb,
the compositional ratio of Li:La:Zr:M in the solid electrolyte is 7-x:3:2-x:x, and a relationship of 0<x<2.0 is satisfied, and
the precursor composition exhibits X-ray diffraction intensity peaks at diffraction angles 2θ of 28.4°, 32.88°, 47.2°, 56.01°, and 58.73° in an X-ray diffraction pattern.

2. The precursor composition for a solid electrolyte according to claim 1, wherein the precursor composition for a solid electrolyte contains nitrate ions.

3. The precursor composition for a solid electrolyte according to claim 1, wherein the M is two or more types of elements selected from Nb, Ta, and Sb.

4. A method for producing a secondary battery, comprising:
a step of forming a solid electrolyte layer by forming a molded material using the precursor composition for a solid electrolyte according to claim 1, and sintering the molded material;
a step of forming a positive electrode at one face of the solid electrolyte layer;
a step of forming a negative electrode at the other face of the solid electrolyte layer; and
a step of forming a current collector in contact with at least one of the positive electrode and the negative electrode.

5. A method for producing a secondary battery, comprising:
a step of forming a positive electrode composite material by forming a molded material including the precursor composition for a solid electrolyte according to claim 1 and a positive electrode active material, and sintering the molded material;
a step of forming a negative electrode at one face of the positive electrode composite material; and
a step of forming a current collector at the other face of the positive electrode composite material.

6. A method for producing a secondary battery, comprising:
a step of forming a negative electrode composite material by forming a molded material including the precursor composition for a solid electrolyte according to claim 1 and a negative electrode active material, and sintering the molded material;
a step of forming a positive electrode at one face of the negative electrode composite material; and
a step of forming a current collector at the other face of the negative electrode composite material.

7. A method for producing a secondary battery, comprising:
a step of forming a sheet of a positive electrode composite material mixture including a first precursor composition for a solid electrolyte and a positive electrode active material;
a step of forming a sheet of a negative electrode composite material mixture including a second precursor composition for a solid electrolyte and a negative electrode active material;
each of the first and second precursor compositions being the precursor composition for the solid electrolyte according to claim 1;
a step of forming a sheet of an electrolyte mixture including a solid electrolyte;
a step of forming a stacked body by stacking the sheet of the positive electrode composite material mixture, the sheet of the electrolyte mixture, and the sheet of the negative electrode composite material mixture in this order;
a step of forming a molded material by molding the stacked body;
a step of firing the molded material; and
a step of forming a current collector at at least one face of the fired molded material.

8. The method for producing a secondary battery according to claim 7, wherein the solid electrolyte is formed using a precursor composition for a garnet-type or garnet-like solid electrolyte containing Li, La, Zr, and M, wherein
the M is one or more types of elements selected from Nb, Ta, and Sb,
the compositional ratio of Li:La:Zr:M in the solid electrolyte is 7-x:3:2-x:x, and a relationship of 0<x<2.0 is satisfied, and
the precursor composition exhibits X-ray diffraction intensity peaks at diffraction angles 2θ of 28.4°, 32.88°, 47.2°, 56.01°, and 58.73° in an X-ray diffraction pattern.
